(19) United States
(12) Patent Application Publication
(10) Pub. No.: US 2025/0097949 A1
(43) Pub. Date: Mar. 20, 2025

(54) COMMON SEARCH SPACE COLLISION HANDLING FOR SUB-BAND FULL DUPLEX SETS OF SYMBOLS

(71) Applicant: QUALCOMM Incorporated, San Diego, CA (US)

(72) Inventors: Jae Ho RYU, San Diego, CA (US); Muhammad Sayed Khairy ABDELGHAFFAR, San Jose, CA (US); James BECKMAN, La Jolla, CA (US)

(21) Appl. No.: 18/883,452

(22) Filed: Sep. 12, 2024

Related U.S. Application Data
(60) Provisional application No. 63/584,009, filed on Sep. 20, 2023.

(51) Int. Cl. H04W 72/23; H04L 5/00; H04L 5/14

(52) U.S. Cl. CPC H04W 72/23; H04L 5/0094; H04L 5/14

(57) ABSTRACT

Various aspects of the present disclosure generally relate to wireless communication. In some aspects, a user equipment (UE) may receive configuration information that schedules a physical downlink control channel (PDCCH) communication associated with a common search space (CSS) in a sub-band full duplex (SBFD) set of symbols. The UE may receive an indication of whether the SBFD set of symbols is to be treated as a non-SBFD set of symbols. The UE may perform one of receiving the PDCCH communication or refraining from receiving the PDCCH communication based on whether the SBFD set of symbols is to be treated as the non-SBFD set of symbols. Numerous other aspects are described.

### CROSS-REFERENCE TO RELATED APPLICATION

This Patent Application claims priority to U.S. Provisional Patent Application No. 63/584,009, filed on Sep. 20, 2023, entitled “COMMON SEARCH SPACE COLLISION HANDLING FOR SUB-BAND FULL DUPLEX SETS OF SYMBOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for common search space collision handling for sub-band full duplex sets of symbols.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information that schedules a physical downlink control channel (PDCCH) communication associated with a common search space (CSS) in a sub-band full duplex (SBFD) set of symbols. The method may include receiving an indication of whether the SBFD set of symbols is to be treated as a non-SBFD set of symbols. The method may include performing one of receiving the PDCCH communication or refraining from receiving the PDCCH communication based on whether the SBFD set of symbols is to be treated as the non-SBFD set of symbols.

Some aspects described herein relate to a method of wireless communication performed by a network node. The method may include transmitting, to a UE, configuration information that schedules a PDCCH communication associated with a CSS in an SBFD set of symbols. The method may include transmitting, to the UE, an indication of whether the SBFD set of symbols is to be treated as a non-SBFD set of symbols. The method may include performing one of transmitting, to the UE, the PDCCH communication or refraining from transmitting the PDCCH communication based on whether the SBFD set of symbols is to be treated as the non-SBFD set of symbols.

Some aspects described herein relate to a UE for wireless communication. The UE may include one or more memories and one or more processors coupled to the one or more memories. The one or more processors may be configured, individually or any combination, to receive configuration information that schedules a PDCCH communication associated with a CSS in an SBFD set of symbols. The one or more processors may be configured, individually or any combination, to receive an indication of whether the SBFD set of symbols is to be treated as a non-SBFD set of symbols. The one or more processors may be configured, individually or any combination, to perform one of receiving the PDCCH communication or refraining from receiving the PDCCH communication based on whether the SBFD set of symbols is to be treated as the non-SBFD set of symbols.

Some aspects described herein relate to a network node for wireless communication. The network node may include one or more memories and one or more processors coupled to the one or more memories. The one or more processors may be configured, individually or any combination, to transmit, to a UE, configuration information that schedules a PDCCH communication associated with a CSS in an SBFD set of symbols. The one or more processors may be configured, individually or any combination, to transmit, to the UE, an indication of whether the SBFD set of symbols is to be treated as a non-SBFD set of symbols. The one or more processors may be configured, individually or any combination, to perform one of transmitting, to the UE, the PDCCH communication or refraining from transmitting the PDCCH communication based on whether the SBFD set of symbols is to be treated as the non-SBFD set of symbols.

Some aspects described herein relate to a non-transitory computer-readable medium that stores a set of instructions for wireless communication by a UE. The set of instructions, when executed by one or more processors of the UE, may cause the UE to receive configuration information that schedules a PDCCH communication associated with a CSS in an SBFD set of symbols. The set of instructions, when executed by one or more processors of the UE, may cause the UE to receive an indication of whether the SBFD set of symbols is to be treated as a non-SBFD set of symbols. The set of instructions, when executed by one or more processors of the UE, may cause the UE to perform one of receiving the PDCCH communication or refraining from receiving the PDCCH communication based on whether the SBFD set of symbols is to be treated as the non-SBFD set of symbols.

Some aspects described herein relate to a non-transitory computer-readable medium that stores a set of instructions for wireless communication by a network node. The set of instructions, when executed by one or more processors of the network node, may cause the network node to transmit, to a UE, configuration information that schedules a PDCCH communication associated with a CSS in an SBFD set of symbols. The set of instructions, when executed by one or more processors of the network node, may cause the network node to transmit, to the UE, an indication of whether the SBFD set of symbols is to be treated as a non-SBFD set of symbols. The set of instructions, when executed by one or more processors of the network node, may cause the network node to perform one of transmitting, to the UE, the PDCCH communication or refraining from transmitting the PDCCH communication based on whether the SBFD set of symbols is to be treated as the non-SBFD set of symbols.

Some aspects described herein relate to an apparatus for wireless communication. The apparatus may include means for receiving configuration information that schedules a PDCCH communication associated with a CSS in an SBFD set of symbols. The apparatus may include means for receiving an indication of whether the SBFD set of symbols is to be treated as a non-SBFD set of symbols. The apparatus may include means for performing one of receiving the PDCCH communication or refraining from receiving the PDCCH communication based on whether the SBFD set of symbols is to be treated as the non-SBFD set of symbols.

Some aspects described herein relate to an apparatus for wireless communication. The apparatus may include means for transmitting, to a UE, configuration information that schedules a PDCCH communication associated with a CSS in an SBFD set of symbols. The apparatus may include means for transmitting, to the UE, an indication of whether the SBFD set of symbols is to be treated as a non-SBFD set of symbols. The apparatus may include means for performing one of transmitting, to the UE, the PDCCH communication or refraining from transmitting the PDCCH communication based on whether the SBFD set of symbols is to be treated as the non-SBFD set of symbols.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a full duplex (FD) zone, a non-FD zone, and self-interference associated with FD communications, in accordance with the present disclosure.

FIG. 5 is a diagram illustrating an example of slot structures associated with sub-band FD (SBFD) schemes, in accordance with the present disclosure.

FIGS. 6A-6C are diagrams of an example associated with common search space (CSS) collision handling for SBFD sets of symbols, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some examples, a user equipment (UE) may be configured to receive a downlink communication in a full duplex (FD) slot and/or a FD set of symbols, such as within a sub-band FD (SBFD) slot and/or a SBFD set of symbols. For example, the UE may be configured with a common search space (CSS) that is associated with monitoring occasions (MOs) for receiving a physical downlink control channel (PDCCH) that occur within an SBFD set of symbols. In examples in which a PDCCH communication associated with a CSS (sometimes referred to herein as a CSS PDCCH communication) collides with SBFD symbols, an SBFD-aware UE (a UE for which a network node's SBFD operation is non-transparent to the UE) may be aware of a collision between the CSS PDCCH communication and the SBFD symbols, but may be unaware of how to handle the collision. Accordingly, whether a particular UE receives or transmits a particular communication in a collision scenario may be left to UE implementation. This may result in a UE missing important control information or other high-priority traffic from a network node and/or a UE selectively transmitting or receiving communications in a transparent manner to the network node, resulting in increased communication errors and thus high power, computing, and network resource consumption for purposes of correcting communication errors. Additionally, or alternatively, in order to avoid communication errors or for a similar purpose, a network node may simply refrain from configuring CSS symbols (e.g., symbols associated with MOs for receiving a CSS PDCCH communication) as SBFD symbols, thus forgoing benefits associated with SBFD operation, such as latency reduction, uplink coverage enhancement, or flexible allocation of uplink and downlink resources, among other benefits.

Some techniques and apparatuses described herein enable enhanced collision handling for SBFD-aware UEs, such as collision handling for a CSS configured with MOs occurring in SBFD symbols. In some aspects, a UE may receive configuration information that schedules a CSS PDCCH communication in an SBFD set of symbols. Moreover, the UE may receive an implicit or explicit indication of whether the SBFD set of symbols is to be treated as a non-SBFD set of symbols, such as for a purpose of receiving or refraining from receiving the CSS PDCCH communication. Accordingly, the UE may perform one of receiving the CSS PDCCH communication or refraining from receiving the CSS PDCCH communication based on whether the SBFD set of symbols is to be treated as the non-SBFD set of symbols.

As a result, the UE and the network node may communicate with more transparency and/or exchange control information or other high-priority traffic, thus communicating with decreased communication errors, leading to reduced power, computing, and network resource consumption otherwise used for purposes of correcting communication errors. Moreover, the techniques and apparatuses may enable configuration of CSS symbols as SBFD symbols, resulting in latency reduction (e.g., by enabling uplink transmissions in legacy downlink slots and/or downlink reception in legacy uplink slots), enhanced uplink coverage, flexible uplink/downlink resource adaptation according to uplink/downlink traffic, and overall more efficient usage of network resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

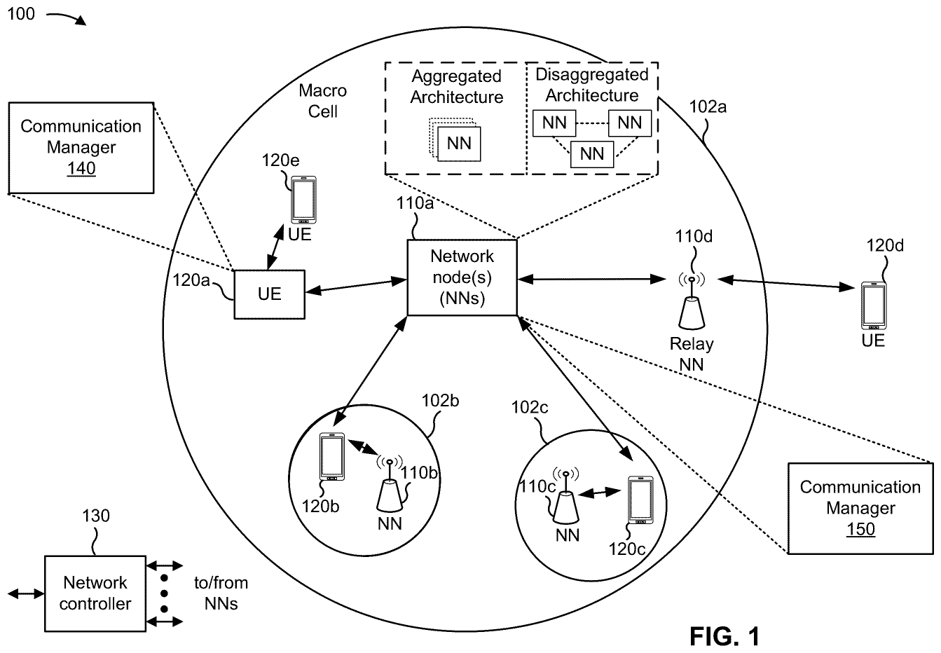

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information that schedules a PDCCH communication associated with a CSS in an SBFD set of symbols; receive an indication of whether the SBFD set of symbols is to be treated as a non-SBFD set of symbols; and perform one of receiving the PDCCH communication or refraining from receiving the PDCCH communication based on whether the SBFD set of symbols is to be treated as the non-SBFD set of symbols. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information that schedules a PDCCH communication associated with a CSS in an SBFD set of symbols; transmit, to the UE, an indication of whether the SBFD set of symbols is to be treated as a non-SBFD set of symbols; and perform one of transmitting, to the UE, the PDCCH communication or refraining from transmitting the PDCCH communication based on whether the SBFD set of symbols is to be treated as the non-SBFD set of symbols. Additionally, or alternatively, the communication manager 150 may perform one or more other operations described herein.

As indicated above, FIG. 1 is provided as an example. Other examples may differ from what is described with regard to FIG. 1.

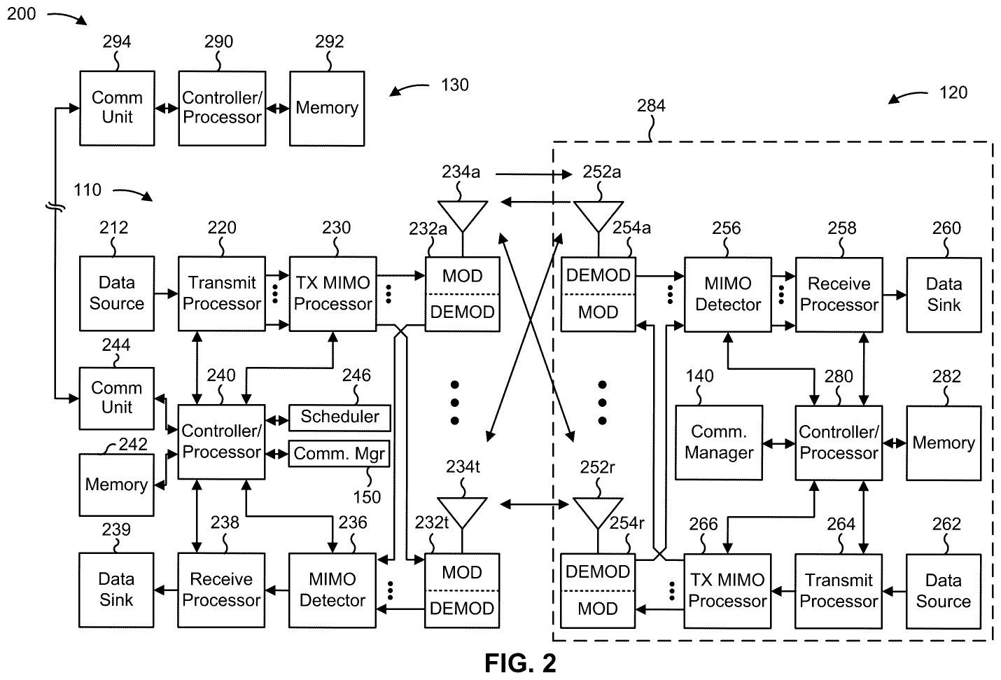

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

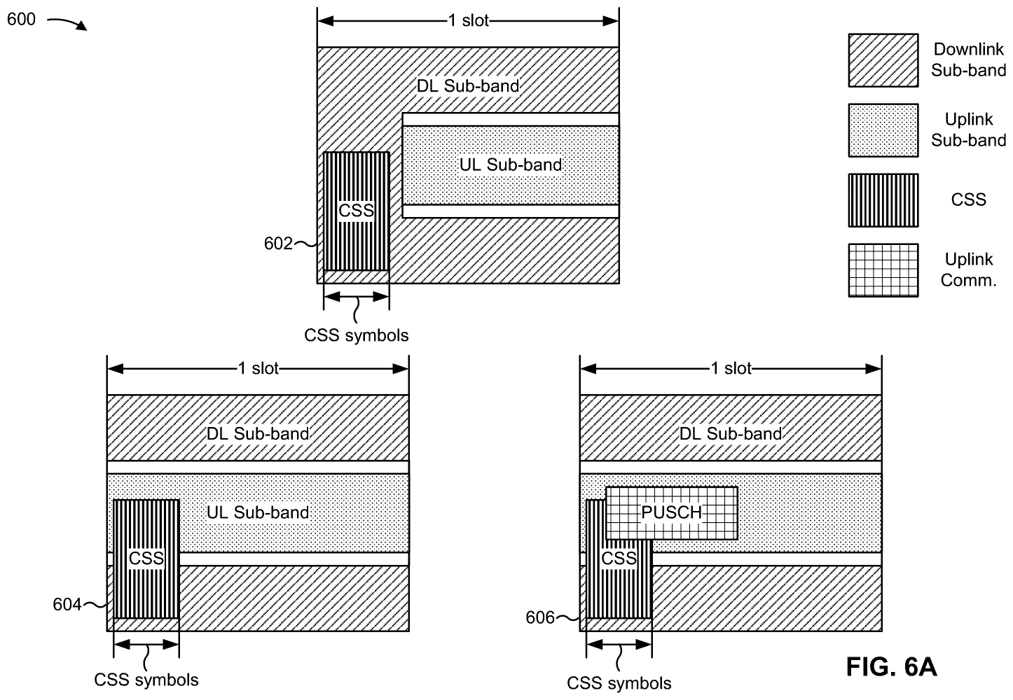

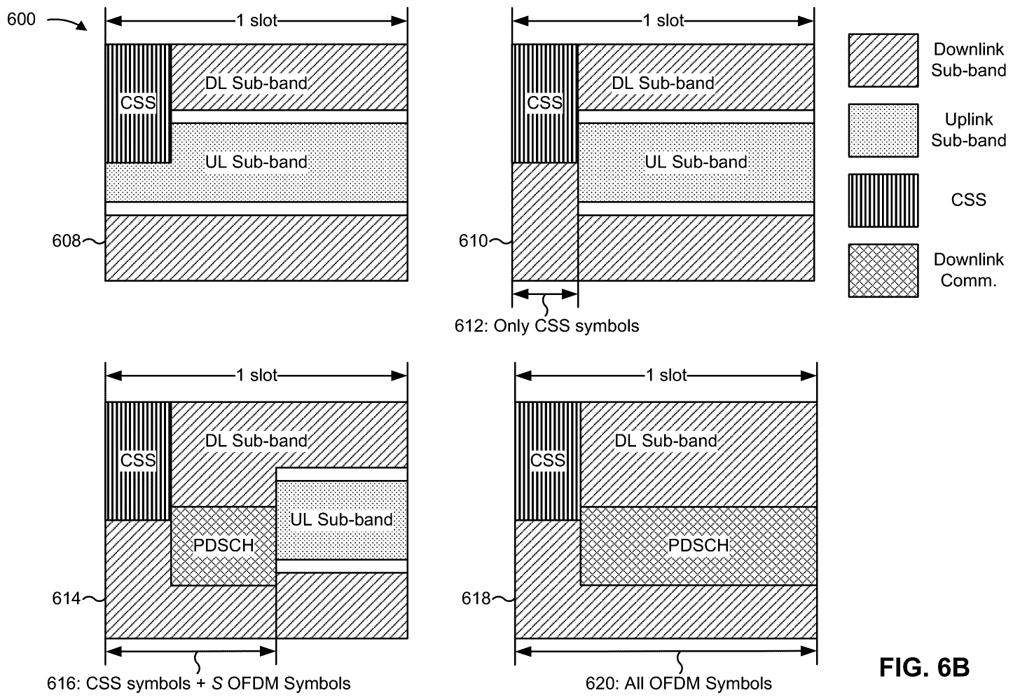

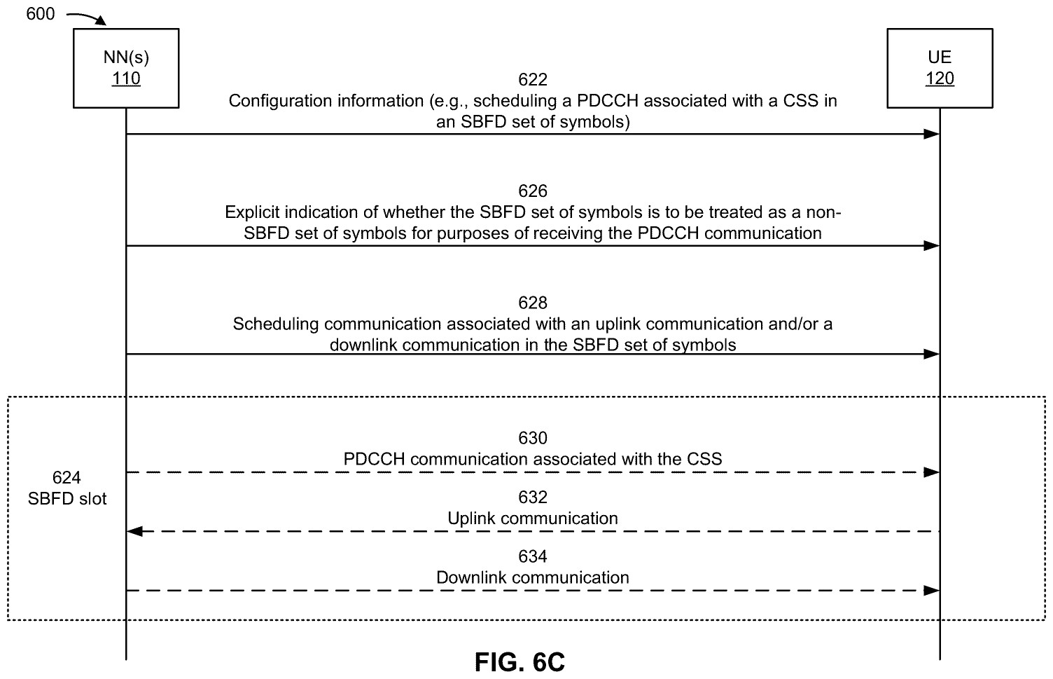

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-10).

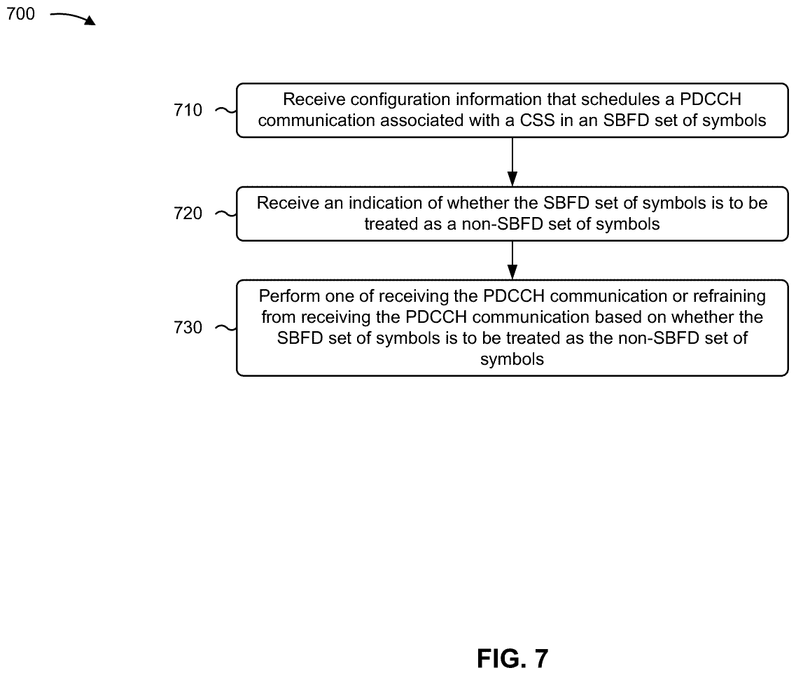

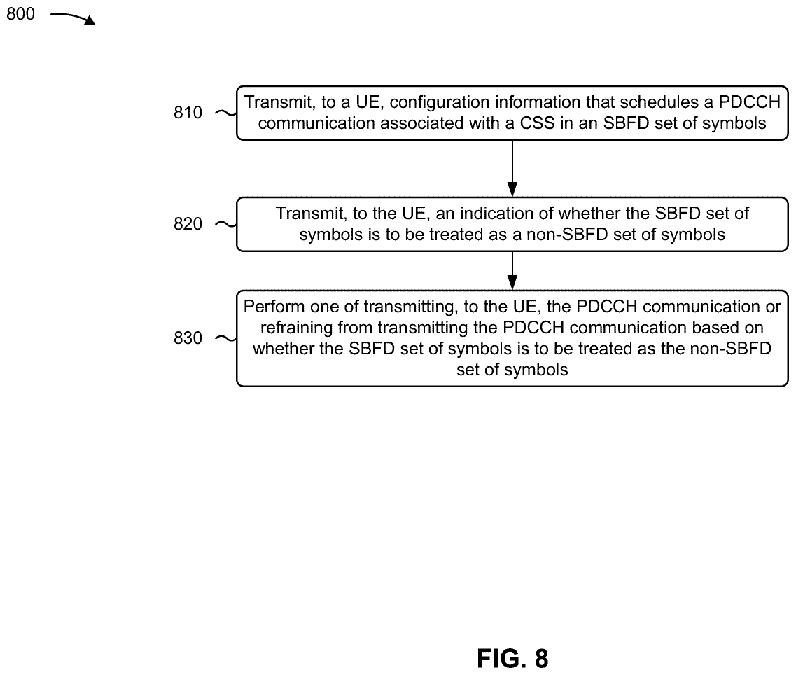

The controller/processor 240 of the network node 110, the controller/processor 280 of the UE 120, and/or any other component(s) of FIG. 2 may perform one or more techniques associated with CSS collision handling for SBFD sets of symbols, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving configuration information that schedules a PDCCH communication associated with a CSS in an SBFD set of symbols; means for receiving an indication of whether the SBFD set of symbols is to be treated as a non-SBFD set of symbols; and/or means for performing one of receiving the PDCCH communication or refraining from receiving the PDCCH communication based on whether the SBFD set of symbols is to be treated as the non-SBFD set of symbols. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, configuration information that schedules a PDCCH communication associated with a CSS in an SBFD set of symbols; means for transmitting, to the UE, an indication of whether the SBFD set of symbols is to be treated as a non-SBFD set of symbols; and/or means for performing one of transmitting, to the UE, the PDCCH communication or refraining from transmitting the PDCCH communication based on whether the SBFD set of symbols is to be treated as the non-SBFD set of symbols. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

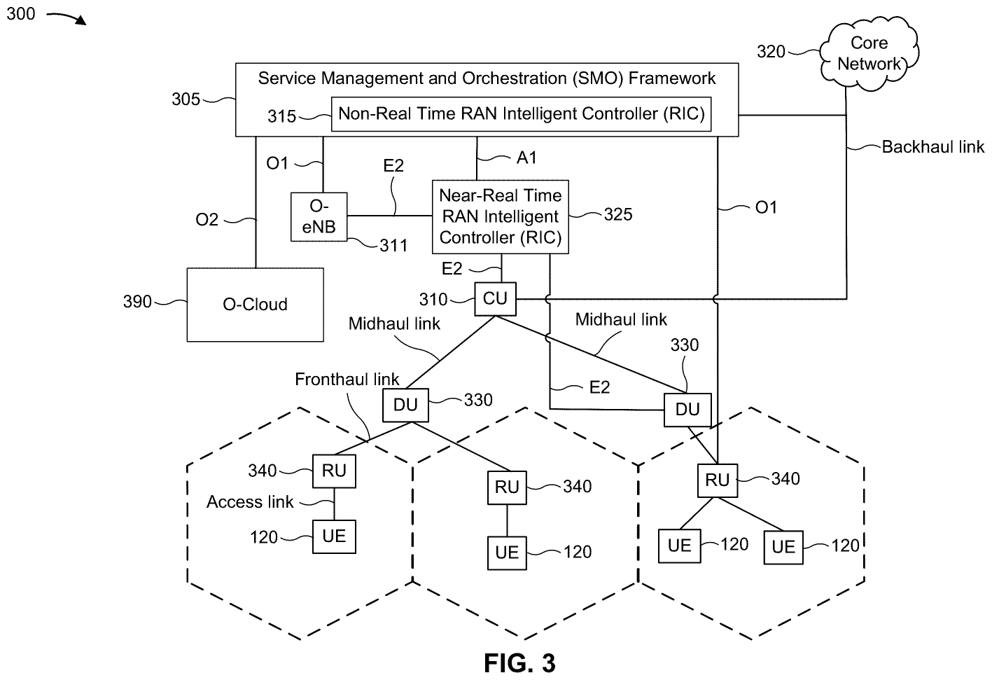

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

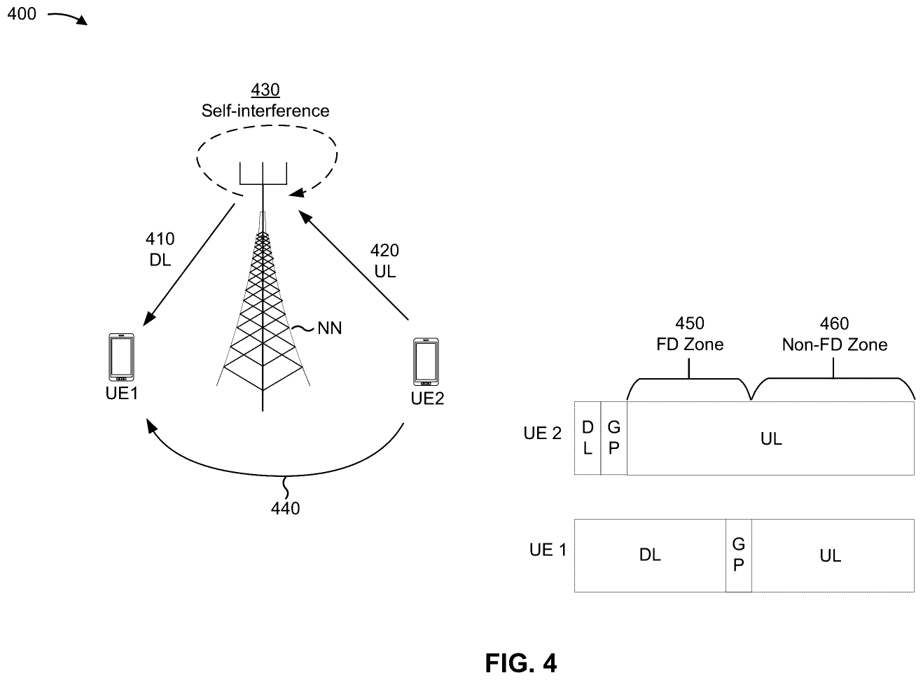

FIG. 4 is a diagram illustrating an example 400 of an FD zone, a non-FD zone, and self-interference associated with FD communications, in accordance with the present disclosure. As shown, example 400 includes a network node (e.g., network node 110), a UE1 (e.g., UE 120), and a UE2 (e.g., another UE 120). In some aspects, the network node 110 may be capable of FD communication. FD communication may include a contemporaneous uplink and downlink communication using the same resources. For example, the network node may perform a DL transmission to a UE1 (shown by reference number 410) and may receive a UL transmission from a UE2 (shown by reference number 420) using the same frequency resources and at least partially overlapping in time.

As shown by reference number 430, the DL transmission from the network node may self-interfere with the UL transmission to the network node. This may be caused by a variety of factors, such as the higher transmit power for the DL transmission (as compared to the UL transmission) and/or radio frequency bleeding. Furthermore, as shown by reference number 440, the UL transmission to the network node 110 from the UE2 may interfere with the DL transmission from the network node to the UE1, thereby diminishing DL performance of the UE1.

An FD zone is shown by reference number 450 and a non-FD zone is shown by reference number 460. “FD zone” may refer to a time period and/or a frequency region in which a wireless communication device (e.g., a network node 110, a UE 120, or a similar device) performs FD communication, and “non-FD zone” may refer to a time period and/or a frequency region in which a wireless communication device performs non-FD communication. The FD zone may be associated with higher self-interference, and therefore a lower signal-to-interference-plus-noise ratio (SINR), than the non-FD zone.

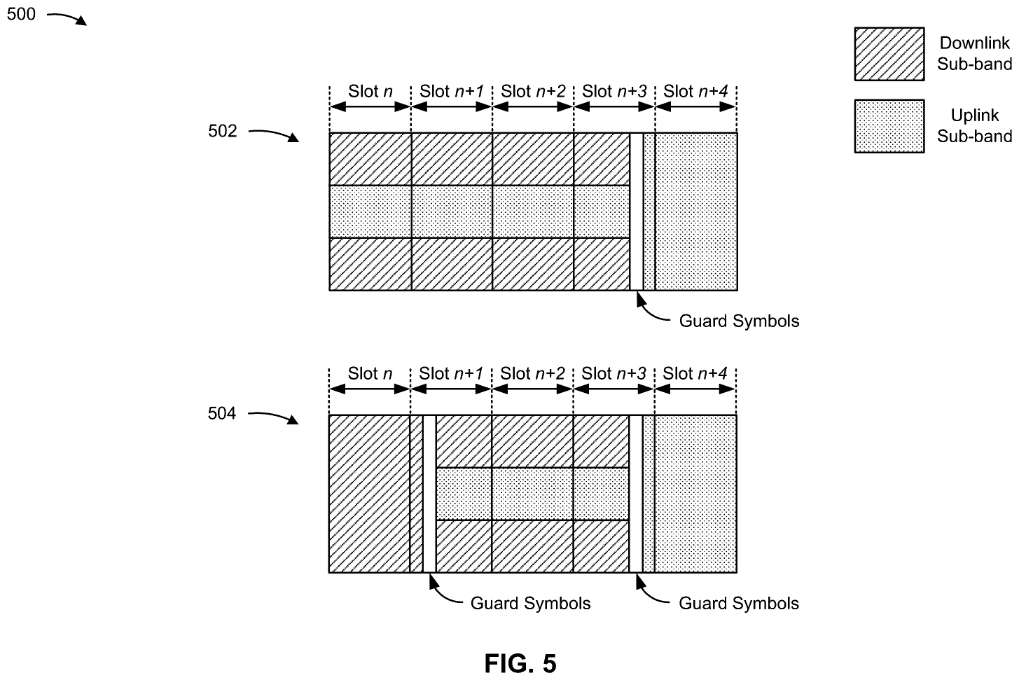

In some cases, a network node 110 may operate using a non-overlapping uplink and downlink sub band; e.g., an SBFD scheme. “SBFD scheme” may refer to an FD mode in which a slot provides bidirectional transmission on different sub-bands within a same component carrier. Example slot structures associated with SBFD schemes are described in more detail below in connection with FIG. 5.

As indicated above, FIG. 4 is provided as an example. Other examples may differ from what is described with respect to FIG. 4.

FIG. 5 is a diagram illustrating an example 500 of slot structures associated with SBFD schemes, in accordance with the present disclosure. In some instances, the example slot structures shown in FIG. 5 may be associated with SBFD operation within a time division duplex (TDD) carrier.

SBFD operation implies simultaneous transmission and reception of downlink communications and uplink communications on a sub-band basis at a network node 110. SBFD operation may enable latency reduction by permitting transmission of uplink channels and/or signals in an uplink sub-band of a semi-statically configured downlink slot (sometimes referred to as a “D slot” and/or a legacy downlink slot) and/or reception of downlink channels and/or signals in a downlink sub-band of a semi-statically configured uplink slot (sometimes referred to as a “U slot” and/or a legacy uplink slot). Additionally, or alternatively, SBFD operation may enable uplink coverage enhancement and/or flexible uplink/downlink resource adaptation according to real-time uplink/downlink traffic.

Reference numbers 502 and 504 show example TDD pattern periods associated with SBFD operation. In the example shown by reference number 502, the TDD pattern period includes five slots (indexed as slot n through slot n+4). Some slots of the example TDD pattern period may include only SBFD symbols (e.g., symbols including a downlink sub-band and an uplink sub-band), and thus may be referred to as SBFD slots. For example, the first three slots of the example TDD pattern period in the example indicated by reference number 502 (e.g., slots n through n+2) are SBFD slots that include a downlink sub-band (shown using cross-hatching) and an uplink sub-band (shown using stippling). As shown in FIG. 5, in some examples one or more sub-bands in an SBFD slot may be non-contiguous sub-bands. For example, the downlink sub-band in the SBFD slots is a non-contiguous sub-band, and thus occupies a top portion of a bandwidth associated with a component carrier and a bottom portion of the bandwidth associated with the component carrier, with the uplink sub-band occupying the middle portion of the bandwidth associated with the component carrier. In some other examples, the uplink sub-band may be a non-contiguous sub-band or both the downlink sub-band and the uplink sub-band may be contiguous sub-bands.

As further shown in the example indicted by reference number 502, some slots of the example TDD pattern period may include only non-SBFD symbols (e.g., downlink-only symbols or uplink-only symbols), and thus may be referred to as downlink-only slots (e.g., D slots) or uplink-only slots (e.g., U slots). For example, the fifth slot (e.g., slot n+4) is an uplink-only slot (e.g., U slot) that includes only uplink symbols. Moreover, some slots may include both SBFD symbols and non-SBFD symbols, and thus may be referred to as a slot with mixed symbols. For example, in the example indicated by reference number 502, the fourth slot (e.g., slot n+3) is a slot with mixed symbols, including SBFD symbols and uplink symbols. In such examples, the slot with mixed symbols may further include guard symbols separating the SBFD symbols from the non-SBFD symbols. Additionally, or alternatively, in some examples, a portion of the TDD frame period associated with switching between SBFD symbols and non-SBFD symbols (e.g., the portion of the TDD frame period associated with the guard symbols in the example indicated by reference number 502) may be referred to as a “transition point.” In some examples, a transition point may be aligned with a slot boundary, while, in some other examples, a transition point may be within a slot (e.g., such as shown in the example indicated by reference number 502).

In some examples, a TDD frame period may be limited to a maximum number of transition points, such as for a purpose of avoiding frequent switching between SBFD symbols and non-SBFD symbols. For example, a TDD frame period may be limited to a maximum of two transition points, including one transition point from non-SBFD symbols to SBFD symbols and one transition point from SBFD symbols to non-SBFD symbols. More particularly, the example TDD frame period shown in connection with reference number 504 includes two transition points, including a first transition point associated with switching from non-SBFD symbols to SBFD symbols (e.g., a transition point from downlink symbols to SBFD symbols shown within slot n+1) and a second transition point associated with switching from SBFD symbols to non-SBFD symbols (e.g., a transition point from SBFD symbols to uplink symbols shown within slot n+3).

In some examples, a UE 120 may be configured to receive, in an SBFD slot, a downlink communication from a network node 110. For example, a UE 120 may be scheduled to receive a communication (e.g., a PDCCH communication) associated with a search space and/or a CSS (e.g., a CSS PDCCH communication) in an SBFD slot. “Search space” may refer to a set of possible locations (e.g., in time and/or frequency) where a PDCCH may be located. A control resource set (CORESET) may include one or more search spaces, such as a UE-specific search space, a group-common search space, and/or a CSS. “CSS” may refer to a set of all possible PDCCH locations across all UEs. In some aspects, a CSS may correspond to a Type 0 CSS (sometimes referred to as Type 0-PDCCH), a Type 0A CSS (sometimes referred to as Type 0A-PDCCH), a Type 1 CSS (sometimes referred to as Type 1-PDCCH), a Type 2 CSS (sometimes referred to as Type 2-PDCCH), a Type 2A CSS (sometimes referred to as Type 2A-PDCCH), or a Type 3 CSS (sometimes referred to as Type 3-PDCCH). A Type 0 CSS may be indicated using a system information (SI) radio network temporary identifier (RNTI) (SI-RNTI) for remaining minimum system information (RMSI) on a primary cell and/or may be associated with a system information block (SIB) decoding use case, such as for decoding SIB1. A Type 0A CSS may be indicated using an SI-RNTI on a primary cell and/or may also be associated with a SIB decoding use case, such as for decoding other SIBs (e.g., SIBs other than SIB1). A Type 1 CSS may be indicated using a random access RNTI (RA-RNTI), a temporary cell RNTI (TC-RNTI), or a cell RNTI (C-RNTI) on a primary cell and/or may be associated with a message 2 (Msg2) and/or message 4 (Msg4) decoding in a random access channel (RACH) use case. A Type 2 CSS may be indicated using a paging RNTI (P-RNTI) on a primary cell and/or may be associated with a paging decoding use case.

In some examples, a network node 110 may configure a CORESET and a search space in a way such that MOs of the search space occur in SBFD symbols, such that the MOs of the search space occur in non-SBFD symbols, such that the MOs of the search space occur in both SBFD symbols and non-SBFD symbols, such that the MOs of the search space do not overlap a boundary of a downlink sub-band in SBFD symbols, or such that the MOs of the search space do overlap a boundary of a downlink sub-band in SBFD symbols, among other examples. Accordingly, in aspects in which a CSS PDCCH communication collides with SBFD symbols, an SBFD-aware UE 120 (a UE 120 for which the network node 110's SBFD operation is non-transparent to the UE 120) may be aware of a collision between the PDCCH communication associated with the CSS and the SBFD symbols, but may otherwise be unaware of how to handle the collision (e.g., the UE 120 may not be specified and/or configured with a rule for handling the collision). Accordingly, whether a particular UE 120 receives or transmits a particular communication in a collision scenario may be left to UE 120 implementation. This may result in a UE 120 missing control information or other high-priority traffic from a network node 110, and/or a UE 120 selectively transmitting or receiving communications in a transparent manner to the network node 110, leading to increased communication errors; high power, computing, and network resource consumption for purposes of correcting communication errors; increased latency and reduced throughput associated with communication channels between a network node 110 and a UE 120; and otherwise inefficient usage of network resources.

Some techniques and apparatuses described herein enable enhanced collision handling for SBFD-aware UEs, such as enhanced collision handling for a CSS configured with MOs occurring in SBFD symbols. In some aspects, a UE 120 may receive configuration information that schedules a PDCCH communication associated with a CSS (e.g., a CSS PDCCH communication) in an SBFD set of symbols. Moreover, the UE 120 may receive an implicit or explicit indication of whether the SBFD set of symbols is to be treated as a non-SBFD set of symbols, such as for a purpose of receiving or refraining from receiving the CSS PDCCH communication. Accordingly, the UE 120 may perform one of receiving the CSS PDCCH communication or refraining from receiving the CSS PDCCH communication based on whether the SBFD set of symbols is to be treated as the non-SBFD set of symbols. As a result, the UE 120 and the network node 110 may communicate with more transparency and/or exchange control information or other high-priority traffic, thus communicating with decreased communication errors, leading to reduced power, computing, and network resource consumption otherwise used for purposes of correcting communication errors; decreased latency and increased throughput associated with communication channels between the network node 110 and the UE 120; and otherwise more efficient usage of network resources.

As indicated above, FIG. 5 is provided as an example. Other examples may differ from what is described with respect to FIG. 5.

FIGS. 6A-6C are diagrams of an example 600 associated with CSS collision handling for SBFD sets of symbols, in accordance with the present disclosure. The example 600 may be associated with a network node 110 (e.g., a CU, a DU, and/or an RU) communicating with a UE 120. In some aspects, the network node 110 and the UE 120 may be part of a wireless network (e.g., wireless network 100). The UE 120 and the network node 110 may have established a wireless connection prior to operations shown in FIGS. 6A-6C. In some aspects, the network node 110 and/or the UE 120 may be capable of SBFD operation. For example, the network node 110 may be capable of SBFD operation and/or the UE 120 may be an SBFD-aware UE for which the network node 110's SBFD operation is non-transparent to the UE 120.

In some aspects, a UE 120 may not expect a set of symbols associated with a CSS (e.g., sometimes referred to herein as CSS symbols, which may be a set of symbols that is scheduled by the network node 110 as a MO for the UE 120 to receive a CSS PDCCH communication) to be configured as an SBFD set of symbols. For example, a wireless communication standard, such as a wireless communication standard promulgated by the 3GPP, may specify that CSS symbols may not be configured as SBFD symbols. For example, as shown in FIG. 6A, and as indicated by reference number 602, CSS symbols may be associated with downlink-only symbols within a slot, such that a CSS and/or a CSS PDCCH communication does not overlap with an uplink sub-band in the slot. In such aspects, a CSS PDCCH communication may not collide with SBFD symbols and/or uplink transmissions, and thus the UE 120 may not need to determine how to handle any CSS collision scenarios. Put another way, in such aspects, the UE 120 may only receive communications in the set of symbols associated with the CSS, and thus there is no risk of colliding communications between uplink transmissions and a CSS PDCCH communication.

In some other aspects, CSS symbols may be permitted to be configured as SBFD symbols, and thus a UE 120 may be capable of identifying whether to receive a downlink communication associated with the CSS symbols (e.g., a CSS PDCCH communication) based at least in part on an indication received by the UE 120. Put another way, when the CSS symbols are semi-statically configured as SBFD symbols (e.g., when the CSS symbols occur within an SBFD slot), the UE 120 may be capable of identifying whether the CSS symbols should be treated as non-SBFD symbols, such as by treating the CSS symbols as downlink symbols (e.g., by applying an automatic gain control (AGC) gain associated with a downlink slot and/or a transmission configuration indicator (TCI) state associated with the downlink slot) in order to receive the CSS PDCCH communication.

More particularly, as shown in FIG. 6A and as indicated by reference number 604, in some aspects CSS symbols may be configured as SBFD symbols (e.g., a MO associated with a CSS may overlap both downlink sub-bands and uplink sub-bands of an SBFD slot), and thus, in some aspects, the CSS symbols may be treated as downlink symbols (e.g., the UE 120 may not be permitted to transmit uplink communications in the uplink sub-band of the CSS symbols), such as for a purpose of receiving a CSS PDCCH communication. Put another way, in the example indicated by reference number 604, the UE 120 may be permitted to only receive communications in the CSS symbols, and thus may not be permitted to transmit communications in the CSS symbols.

In some aspects, when treating the CSS symbols as non-SBFD symbols (e.g., downlink symbols), the UE 120 may be capable of receiving additional downlink communications (e.g., communications in addition to a CSS PDCCH communication) in the CSS symbols, such as another frequency division multiplexed (FDMed) downlink communication (e.g., a FDMed physical downlink shared channel (PDSCH) communication) that is rated-matched around a CORESET of the CSS. Additionally, or alternatively, when treating the CSS symbols as non-SBFD symbols (e.g., downlink symbols), the UE 120 may be capable of receiving downlink communications (e.g., a PDCCH communication associated with the CSS and/or any other FDMed downlink communication) in all frequency resources in the CSS symbols, including the uplink sub-band of the SBFD set of symbols. For example, as indicated by the example shown in connection with reference number 604, the CSS may overlap with the uplink sub-band, and thus in some aspects the UE 120 may have a capability of receiving a downlink communication in all frequency resources in the CSS symbols, including those that overlap with the uplink sub-band, such as for a purpose of receiving a CORESET that at least partially overlaps with the uplink sub-band. However, in some other aspects, when treating the CSS symbols as downlink symbols, the UE 120 may be capable of receiving downlink communications (e.g., a PDCCH communication associated with the CSS and/or any other FDMed downlink communication) in only a downlink sub-band of the CSS symbols.

In some other aspects, a UE 120 may be capable of identifying whether the UE 120 is to transmit communications in the CSS symbols (e.g., in an uplink sub-band of the CSS symbols) and/or receive communications in the CSS symbols (e.g., in a downlink sub-band of the CSS symbols or in both the downlink sub-band and an uplink sub-band of the CSS symbols, as described above) based at least in part on an implicit or explicit indication received by the UE 120. More particularly, as shown in FIG. 6A, and as indicated by reference number 606, the UE 120 may selectively receive a CSS PDCCH communication in the CSS symbols, such as by treating the CSS symbols as non-SBFD symbols, or transmit a physical uplink shared channel (PUSCH) communication in the CSS symbols, such as by treating the CSS symbols as SBFD symbols and/or by transmitting the PUSCH communication in the uplink sub-band of the CSS symbols.

For example, based at least in part on a priority rule, configuration information, explicit signaling, or the like, the UE 120 may identify whether to treat the CSS symbols as SBFD symbols, such as for a purpose of transmitting an uplink communication in the uplink sub-band of the SBFD set of symbols, or to treat the CSS symbols as non-SBFD symbols, such as for a purpose of receiving a CSS PDCCH communication and/or another downlink communications in the CSS symbols. In some aspects, the UE 120 may identify whether to treat the CSS symbols as SBFD symbols or non-SBFD symbols based at least in part on the configuration information that configures the CSS. For example, a UE 120 may understand a configuration of a CSS in an SBFD set of symbols as an implicit indication that uplink transmissions are not to occur in the CSS symbols (e.g., configuring CSS symbols as SBFD symbols may be an implicit indication that the set of symbols are to be treated as downlink symbols for receiving a CSS PDCCH communication). Additionally, or alternatively, a UE 120 may understand a scheduling communication, such as a scheduling downlink control information (DCI), that schedules an uplink transmission that at least partially overlaps with the CSS symbols as an implicit indication that uplink transmissions may occur in the CSS symbols (e.g., transmitting a scheduling DCI may be an implicit indication that that the CSS symbols are not to be treated as downlink symbols and/or that the UE 120 may skip PDCCH monitoring and instead transmit a communication in the CSS symbols).

Similarly, a UE 120 may be configured with a priority rule, such that the UE 120 understands that being scheduled with an higher-priority communication in the CSS symbols than the CSS PDCCH communication as an implicit indication that uplink transmissions may occur in the set of symbols (e.g., that the set of symbols are not to be treated as downlink symbols and/or that the UE 120 may skip PDCCH monitoring and instead transmit or receive a communication in the CSS symbols). For example, the priority rule may indicate that some semi-statically scheduled uplink transmissions may be associated with a higher priority than a priority of a CSS PDCCH communication, while some semi-statically scheduled uplink transmissions may be associated with a lower priority than a CSS PDCCH communication.

In some other aspects, the network node 110 may transmit, and the UE 120 may receive, an explicit indication (e.g., via RRC signaling, one or more MAC control elements (MAC-CEs), or one or more DCI communications, among other examples) that indicates whether the UE 120 should treat the CSS symbols as non-SBFD set of symbols, which is sometimes referred to herein as an explicit CSS indication. Accordingly, the UE 120 may identify whether to treat the CSS symbols as non-SBFD symbols (e.g., in order to receive a CSS PDCCH communication) or else treat the CSS symbols as SBFD symbols (e.g., in order to transmit an uplink communication in an uplink sub-band of the CSS symbols) based at least in part on the explicit CSS indication. Aspects of implicit and explicit indications are described in more detail below in connection with FIG. 6C.

In some aspects, when CSS symbols are to be treated as non-SBFD symbols, the UE 120 may treat only the CSS symbols as non-SBFD symbols while treating the remaining symbols within an SBFD slots as SBFD symbols, or else the UE 120 may treat the CSS symbols as well as additional symbols within the slot as non-SBFD symbols. For example, as shown in FIG. 6B, and as indicated by reference number 608, the CSS symbols may be configured within an SBFD slot, such that the CSS symbols are associated with SBFD symbols and/or such that the CSS symbols overlap a downlink sub-band and an uplink sub-band of the SBFD slot. In some aspects, as indicated by the example shown in connection with reference number 610, based on the configuration information, an implicit or explicit indication transmitted by the network node 110 to the UE 120, a rule specified by a wireless communication standard (e.g., a wireless communication standard promulgated by the 3GPP), or otherwise, the UE 120 may treat only the CSS symbols as non-SBFD symbols (e.g., downlink symbols). More particularly, as shown by reference number 612, in this example only the CSS symbols are treated as non-SBFD symbols (e.g., as downlink symbols), with the other symbols of the SBFD slot remaining as SBFD symbols. Treating only the CSS symbols as non-SBFD symbols may be useful in aspects in which a CSS PDCCH communication is not associated with a subsequent PDSCH communication (e.g., Type 3 CSS), and thus SBFD benefits may be maintained for the remainder of the slot (e.g., the portion of the SBFD slot not overlapping the CSS symbols).

In some other aspects, as indicated by the example shown in connection with reference number 614, based on the configuration information, an implicit or explicit indication transmitted by the network node 110 to the UE 120, a rule specified by a wireless communication standard (e.g., a wireless communication standard promulgated by the 3GPP), or otherwise, the UE 120 may treat the CSS symbols and an additional set of symbols (e.g., S symbols) as non-SBFD symbols (e.g., downlink symbols). More particularly, as shown by reference number 616, in this example the CSS symbols and an additional S symbols are treated as non-SBFD symbols (e.g., as downlink symbols), with the other symbols of the SBFD slot remaining as SBFD symbols. In such aspects, the network node 110 may indicate, to the UE 120, the additional quantity of symbols (e.g., S symbols) to be treated as non-SBFD symbols, such as via RRC signaling. Treating the CSS symbols and the additional S symbols as non-SBFD symbols may be useful in aspects in which a CSS PDCCH is associated with a subsequent PDSCH communication, such as aspects associated with a type of CSS other than a Type 3 CSS.

In some other aspects, as indicated by the example shown in connection with reference number 618, based on the configuration information, an implicit or explicit indication transmitted by the network node 110 to the UE 120, a rule specified by a wireless communication standard (e.g., a wireless communication standard promulgated by the 3GPP), or otherwise, the UE 120 may treat all OFDM symbols within a slot containing the CSS as non-SBFD symbols (e.g., downlink symbols). More particularly, as shown by reference number 620, in this example all OFDM symbols of the SBFD slot are treated as non-SBFD symbols (e.g., as downlink symbols). Treating all OFDM symbols of the SBFD slot as non-SBFD symbols may be useful in aspects in which a CSS PDCCH communication is associated with a subsequent PDSCH communication, such as aspects associated with a type of CSS other than a Type 3 CSS.

FIG. 6C shows example signaling that may be utilized in accordance with CSS collision handling for SBFD sets of symbols, such as in accordance the operations described above in connection with FIGS. 6A and 6B. As shown in FIG. 6C, and as indicated by reference number 622, the network node 110 may transmit, and the UE 120 may receive, configuration information. In some aspects, the UE 120 may receive the configuration information via one or more of system information (e.g., a master information block (MIB) and/or a SIB, among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may be based at least in part on a capability of the UE 120 (e.g., whether the UE 120 is an SBFD-aware UE). In that regard, the UE 120 may transmit, and the network node 110 may receive, a capabilities report. The capabilities report may indicate whether the UE 120 supports a feature and/or one or more parameters related to the feature. For example, the capability information may indicate a capability and/or parameter for SBFD operation. As another example, the capabilities report may indicate whether the UE 120 is an SBFD-aware UE. One or more operations described herein may be based on capability information of the capabilities report. For example, the UE 120 may perform a communication in accordance with the capability information, or may receive configuration information that is in accordance with the capability information. In some aspects, the capabilities report may indicate UE support for collision handling when a CSS is scheduled in an SBFD set of symbols.

In some aspects, the configuration information described in connection with reference number 622 and/or the capabilities report may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

In some aspects, the configuration information may schedule a PDCCH communication associated with a CSS in an SBFD set of symbols, such as within an SBFD slot 624. For example, the configuration information may configure CSS symbols such that one or more MOs associated with the CSS occur within the SBFD slot 624 and/or overlap with an uplink sub-band of the SBFD slot 624, as described above in connection with reference number 608 of FIG. 6B.

In that regard, the SBFD set of symbols in which the CSS is to occur (e.g., the CSS symbols) may be a subset of OFDM symbols associated with the SBFD slot 624. In such aspects, the configuration information may indicate whether other SBFD symbols in the SBFD slot 624 are to be treated as non-SBFD symbols (e.g., downlink symbols) when the CSS symbols are treated as non-SBFD symbols, as described above in connection with the various examples shown in FIG. 6B. For example, in some aspects, the configuration information may indicate that, when the CSS symbols are to be treated as non-SBFD symbols, only the CSS symbols are to be treated as non-SBFD symbols (e.g., no additional OFDM symbols within the SBFD slot are to be treated as non-SBFD symbols), such as described above in connection with reference numbers 610 and 612 of FIG. 6B. In some other aspects, the configuration information may indicate that, when the CSS symbols are to be treated as non-SBFD symbols, the CSS symbols and an additional set of OFDM symbols (e.g., S OFDM symbols) of the SBFD slot 624 are to be treated as non-SBFD of symbols, as described above in connection with reference numbers 614 and 616 of FIG. 6B. In some other aspects, the configuration information may indicate that, when the CSS symbols are to be treated as non-SBFD symbols, all OFDM symbols of the SBFD slot 624 are to be treated as the non-SBFD set of symbols, as described above in connection with reference numbers 618 and 620 of FIG. 6B.

The UE 120 may configure itself based at least in part on the configuration information. In some aspects, the UE 120 may be configured to perform one or more operations described herein based at least in part on the configuration information.

As described above in connection with FIG. 6A, in some aspects the UE 120 may receive an indication (e.g., an implicit indication or an explicit indication) of whether the CSS symbols are to be treated as non-SBFD symbols. For example, in some aspects, the indication of whether the CSS symbols are to be treated as non-SBFD symbols is associated with the configuration information described above in connection with reference number 622. Put another way, receiving a configuration of a CSS in the SBFD slot 624 may implicitly indicate to the UE 120 that the UE 120 is to receive a PDCCH communication in the CSS symbols (and thus that the UE 120 is not to transmit an uplink communication in an uplink sub-band of the CSS symbols).

Additionally, or alternatively, the indication of whether the CSS symbols are to be treated as non-SBFD symbols may be based at least in part on a type of the CSS, such as one of a Type 0 CSS, a Type 0A CSS, a Type 1 CSS, a Type 2 CSS, a Type 2A CSS, or a Type 3 CSS. For example, a wireless communication standard (e.g., a wireless communication standard promulgated by the 3GPP) may specify that for a certain type of CSS (e.g., Type 0 CSS and/or Type 0A CSS, which may be associated with SIB1 or other system information (OSI), among other examples), an SBFD set of symbols that collides with the CSS should be treated as a non-SBFD set of symbols (e.g., converted to downlink symbols), such that a UE 120 does not miss SIB1, OSI, or the like. Accordingly, receiving a configuration of a certain type of CSS (e.g., Type 0 CSS or Type 0A CSS) in the SBFD slot 624 may implicitly indicate to the UE 120 that the UE 120 is to receive a PDCCH communication in the CSS symbols (and thus that the UE 120 is not to transmit an uplink communication in an uplink sub-band of the CSS symbols).

In some aspects, the network node 110 may transmit, and the UE 120 may receive, an explicit indication (e.g., an explicit CSS indication) that indicates whether the UE 120 is to treat the CSS symbols as non-SBFD symbols. More particularly, as indicated by reference number 626, the network node 110 may transmit, and the UE 120 may receive, an explicit CSS indication that indicates whether the UE 120 is to treat the CSS symbols as non-SBFD symbols. For example, the network node 110 may transmit, and the UE 120 may receive, the explicit CSS indication in aspects in which the CSS is associated with an optional CSS, such as a Type 1 CSS (e.g., a CSS associated with an RA-RNTI and/or a TC-RNTI), a Type 2 CSS and/or a Type 2A CSS (e.g., a CSS associated with a P-RNTI), or a Type 3 CSS, among other examples. In such aspects, when the explicit CSS indication indicates that the CSS symbols are to be treated as non-SBFD symbols, the UE 120 may assume that the portion of the SBFD slot 624 that collides with the CSS is a non-SBFD set of symbols (e.g., a downlink set of symbols). In that regard, the UE 120 may apply an AGC gain associated with the non-SBFD set of symbols (e.g., a downlink slot) for receiving a CSS PDCCH communication, the UE 120 may apply a TCI associated with the non-SBFD set of symbols for receiving the CSS PDCCH communication, and/or the UE 120 may apply another parameter associated with the non-SBFD set of symbols for receiving the CSS PDCCH communication.

On the other hand, when the explicit CSS indication indicates that the CSS symbols are not to be treated as non-SBFD symbols, the network node 110 may use the colliding SBFD symbols opportunistically, such as for a purpose of scheduling an uplink transmission in an uplink sub-band of the SBFD slot 624 when there is no broadcast or multicast scheduling associated with the SBFD slot 624.

In some aspects, the explicit CSS indication may be a common indication associated with multiple CSS types (e.g., multiple ones of a Type 0 CSS, a Type 0A CSS, a Type 1 CSS, a Type 2 CSS, a Type 2A CSS, or a Type 3 CSS, among other examples), while, in some other aspects, the explicit CSS indication may be separate indication specific to a certain CSS type (e.g., the explicit CSS indication may be associated with a single CSS type, such as only one of a Type 0 CSS, a Type 0A CSS, a Type 1 CSS, a Type 2 CSS, a Type 2A CSS, or a Type 3 CSS, among other examples). In aspects in which the explicit CSS indication is a common indication, the explicit CSS indication may be transmitted by the network node 110, and received by the UE 120, in a SIB. In aspects in which the explicit CSS indication is a separate indication specific to a certain CSS type, the explicit CSS indication may be transmitted by the network node 110, and received by the UE 120, in one of a SIB or RRC signaling. For example, for an explicit CSS indication that is specific to one of a Type 1 CSS, a Type 2 CSS, or a Type 2A CSS, the explicit CSS indication may be transmitted via a SIB and/or a common PDCCH configuration information element (IE) (sometimes referred to as a PDCCHConfigCommon IE). For an explicit CSS indication that is specific to a Type 3 CSS, the explicit CSS indication may be transmitted via a search space configuration of the CSS.

In some other aspects, the indication of whether the CSS symbols are to be treated as the non-SBFD set of symbols may be associated with a scheduling communication transmitted by the network node 110 to the UE 120. Put another way, receiving a scheduling communication that schedules an uplink communication in the CSS symbols may implicitly indicate to the UE 120 that the UE 120 is to transmit the uplink communication in the CSS symbols (and thus that the UE 120 is not to treat the CSS symbols as non-SBFD symbols to receive the PDCCH communication). Accordingly, as shown by reference number 628, the network node 110 may transmit, and the UE 120 may receive, a scheduling communication scheduling an uplink transmission in the SBFD set of symbols, which may serve as the indication of whether the CSS symbols are to be treated as non-SBFD symbols.

Additionally, or alternatively, the indication of whether the CSS symbols are to be treated as the non-SBFD set of symbols may be based on a priority of overlapping communications scheduled in the SBFD slot 624. For example, the UE 120 may be configured (e.g., via the configuration information described above in connection with reference number 622) with priority information indicating a priority level of certain communications that may be scheduled in the SBFD slot 624. Accordingly, when the scheduling communication described above in connection with reference number 628 schedules an uplink transmission that overlaps the CSS PDCCH communication and that is associated with a higher priority than a priority associated with the CSS PDCCH communication, then the UE 120 may refrain from monitoring the CSS and instead transmit the uplink communication (e.g., the UE 120 may not treat the CSS symbols as non-SBFD symbols). On the other hand, when the scheduling communication described above in connection with reference number 628 schedules an uplink transmission that is associated with a lower priority than a priority associated with the CSS PDCCH communication, then the UE 120 may refrain from transmitting the uplink communication and may instead monitor the CSS for the PDCCH communication (e.g., the UE 120 may treat the CSS symbols as non-SBFD symbols).

Moreover, in aspects in which the CSS symbols are not to be treated as non-SBFD symbols, the network node 110 may opportunistically use the SBFD slots for scheduling certain downlink communications and/or simultaneous downlink/uplink scheduling, such as when the network node 110 refrains from transmitting a PDCCH communication associated with the CSS in the CSS symbols. For example, the network node 110 may dynamically use the CSS symbols for broadcast or multicast PDCCH and/or PDSCH scheduling, or simultaneous downlink/uplink scheduling, among other examples. In such aspects, the communication shown in connection with reference number 628 may be used as a scheduling communication that schedules one of a downlink communication or an uplink communication in the SBFD slot 624. Aspects of uplink communications or downlink communications that may be received in the SBFD set of symbols are described in more detail below in connection with reference numbers 630-634.

As indicated by reference number 630, the network node 110 may selectively transmit, and/or the UE 120 may selectively receive, the PDCCH communication that is associated with the CSS (e.g., the CSS PDCCH communication). More particularly, the network node 110 may perform one of transmitting, to the UE 120, the CSS PDCCH communication or refraining from transmitting the CSS PDCCH communication based on whether the CSS symbols are to be treated as non-SBFD symbols, and/or the UE 120 may perform one of receiving the CSS PDCCH communication or refraining from receiving the CSS PDCCH communication based on whether the CSS symbols are to be treated as non-SBFD symbols. In aspects in which the network node 110 transmits the CSS PDCCH communication and/or in aspects in which the UE 120 receives the CSS PDCCH communication, the CSS PDCCH communication may be transmitted by the network node 110 and/or received by the UE 120 in only a downlink sub-band of the SBFD slot 624. Put another way, the CSS symbols may still be treated as SBFD symbols and thus the UE 120 may be expected to monitor only the downlink sub-band of the CSS symbols for the CSS PDCCH communication.

In some other aspects, the CSS PDCCH communication may be transmitted by the network node 110 and/or received by the UE 120 in a downlink sub-band of the SBFD slot 624 and an uplink sub-band of the SBFD slot 624. Put another way, the UE 120 may be configured to receive the CSS PDCCH communication (and/or any additional downlink transmission, such as a FDMed PUSCH communication that is rate-matched around the CORESET of the CSS) in all frequency resources in the CSS symbols, including the uplink sub-band, such as by treating the CSS symbols as non-SBFD symbols. In such aspects, the UE 120 may receive the PDCCH communication based at least in part on applying at least one of AGC gain associated with a non-SBFD slot (e.g., a downlink slot) or a TCI state associated with the non-SBFD slot (e.g., the downlink slot).

Moreover, as described above in connection with reference number 628, in some aspects the network node 110 may schedule an uplink communication and/or a downlink communication in the SBFD slot 624, such as an uplink communication and/or a downlink communication that at least partially overlaps with the CSS symbols. Accordingly, as indicated by reference number 632, the UE 120 may transmit, and the network node 110 may receive, an uplink communication in the CSS symbols of the SBFD slot 624, and/or, as indicated by reference number 634, the network node 110 may transmit, and the UE 120 may receive, a downlink communication in the CSS symbols of the SBFD slot 624. For example, UE 120 may transmit the uplink communication based at least in part on the uplink communication being associated with a higher priority than a priority associated with the CSS PDCCH communication. Additionally, or alternatively, the network node 110 may transmit the downlink communication (e.g., a PUSCH communication associated with the CSS PDCCH communication) in symbols following the CSS symbols (as described above in connection with reference numbers 614-620 of FIG. 6B) and/or another downlink communication that at least partially overlaps with the CSS symbols (e.g., broadcast and/or multicast PDCCH and/or PDSCH scheduling when no CSS PDCCH is to be transmitted).

In some aspects, whether UE 120 is to transmit the uplink communication shown in connection with reference number 632 may be based at least in part on a type of the uplink communication that is scheduled. For example, the UE 120 may refrain from transmitting certain semi-statically scheduled uplink transmission in the CSS symbols based at least in part on the CSS symbols not being treated as the non-SBFD symbols. For example, the UE 120 may not be permitted to transmit a periodic sounding reference signal (P-SRS) communication, a configured grant physical uplink shared channel (CG-PUSCH) communication, a periodic physical uplink control channel (P-PUCCH) communication, or the like in an SBFD slot that collides with a CSS. Accordingly, in such aspects the UE 120 may refrain from transmitting a P-SRS communication, a CG-PUSCH communication, a P-PUCCH communication, and/or a similar semi-statically scheduled uplink transmission in the CSS symbols. Additionally, or alternatively, the UE 120 may be permitted to transmit a dynamically scheduled uplink transmission in the CSS symbols (e.g., the network node 110 may implicitly indicate that the UE 120 does not need to monitor for a CSS PDCCH communication when the network node 110 dynamically schedules an uplink transmission that at least partially overlaps with the CSS symbols, as described above in connection with reference number 628). Accordingly, based at least in part on being scheduled with a dynamic uplink transmission (e.g., via the scheduling communication described above in connection with reference number 628) and/or receiving an implicit or explicit indication that the CSS symbols are not to be treated as non-SBFD symbols, the UE 120 may transmit the dynamically scheduled uplink transmission in the operations shown in connection with reference number 632.

Based at least in part on the UE 120 and/or the network node 110 performing CSS collision handling in SBFD sets of symbols, the UE 120 and/or the network node 110 may conserve computing, power, network, and/or communication resources that may have otherwise been consumed by correcting communication errors associated with colliding communications in SBFD sets of symbols. For example, based at least in part on the UE 120 and/or the network node 110 performing CSS collision handling in SBFD sets of symbols, the UE 120 and the network node 110 may communicate with a reduced error rate, which may conserve computing, power, network, and/or communication resources that may have otherwise been consumed to detect and/or correct communication errors.

As indicated above, FIGS. 6A-6C are provided as an example. Other examples may differ from what is described with respect to FIGS. 6A-6C.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with CSS collision handling for SBFD sets of symbols.

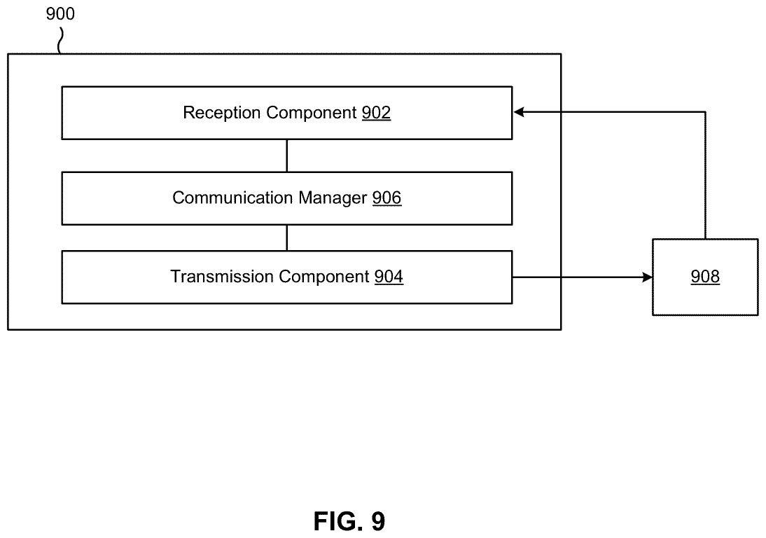

As shown in FIG. 7, in some aspects, process 700 may include receiving configuration information that schedules a PDCCH communication associated with a CSS in an SBFD set of symbols (block 710). For example, the UE (e.g., using reception component 902 and/or communication manager 906, depicted in FIG. 9) may receive configuration information that schedules a PDCCH communication associated with a CSS in an SBFD set of symbols, as described above.

As further shown in FIG. 7, in some aspects, process 700 may include receiving an indication of whether the SBFD set of symbols is to be treated as a non-SBFD set of symbols (block 720). For example, the UE (e.g., using reception component 902 and/or communication manager 906, depicted in FIG. 9) may receive an indication of whether the SBFD set of symbols is to be treated as a non-SBFD set of symbols, as described above.

As further shown in FIG. 7, in some aspects, process 700 may include performing one of receiving the PDCCH communication or refraining from receiving the PDCCH communication based on whether the SBFD set of symbols is to be treated as the non-SBFD set of symbols (block 730). For example, the UE (e.g., using communication manager 906, depicted in FIG. 9) may perform one of receiving the PDCCH communication or refraining from receiving the PDCCH communication based on whether the SBFD set of symbols is to be treated as the non-SBFD set of symbols, as described above.

Process 700 may include additional aspects, such as any single aspect or any combination of aspects described below and/or in connection with one or more other processes described elsewhere herein.

In a first aspect, the indication of whether the SBFD set of symbols is to be treated as the non-SBFD set of symbols is associated with the configuration information, and performing the one of receiving the PDCCH communication or refraining from receiving the PDCCH communication includes receiving the PDCCH communication based at least in part on treating the SBFD set of symbols as the non-SBFD set of symbols.

In a second aspect, alone or in combination with the first aspect, process 700 includes receiving the PDCCH communication only in one or more downlink sub-bands associated with the SBFD set of symbols.

In a third aspect, alone or in combination with one or more of the first and second aspects, process 700 includes receiving the PDCCH communication in one or more downlink sub-bands associated with the SBFD set of symbols and one or more uplink sub-bands or guard bands associated with the SBFD set of symbols.

In a fourth aspect, alone or in combination with one or more of the first through third aspects, the indication of whether the SBFD set of symbols is to be treated as the non-SBFD set of symbols is a communication that schedules, in the SBFD set of symbols, an uplink transmission that is associated with a higher priority than a priority associated with the PDCCH communication, and performing the one of receiving the PDCCH communication or refraining from receiving the PDCCH communication includes refraining from receiving the PDCCH communication based at least in part on receiving the communication that schedules the uplink transmission.

In a fifth aspect, alone or in combination with one or more of the first through fourth aspects, the indication of whether the SBFD set of symbols is to be treated as the non-SBFD set of symbols is based at least in part on a type of the CSS that is associated with the PDCCH communication.

In a sixth aspect, alone or in combination with one or more of the first through fifth aspects, the type of the CSS is one of a Type 0 CSS or a Type 0A CSS, and performing the one of receiving the PDCCH communication or refraining from receiving the PDCCH communication includes receiving the PDCCH communication based at least in part on the type of the CSS being the one of the Type 0 CSS or the Type 0A CSS.

In a seventh aspect, alone or in combination with one or more of the first through sixth aspects, the indication of whether the SBFD set of symbols is to be treated as the non-SBFD set of symbols is an explicit CSS indication.

In an eighth aspect, alone or in combination with one or more of the first through seventh aspects, the explicit CSS indication indicates that the SBFD set of symbols is to be treated as the non-SBFD set of symbols, and performing the one of receiving the PDCCH communication or refraining from receiving the PDCCH communication includes receiving the PDCCH communication based at least in part on applying at least one of an automatic gain control gain associated with a non-SBFD slot or a transmission configuration indicator state associated with the non-SBFD slot.

In a ninth aspect, alone or in combination with one or more of the first through eighth aspects, the explicit CSS indication indicates that the SBFD set of symbols is not to be treated as the non-SBFD set of symbols, and the process 700 further comprises receiving a scheduling communication scheduling an uplink transmission in the SBFD set of symbols.

In a tenth aspect, alone or in combination with one or more of the first through ninth aspects, the explicit CSS indication is associated with multiple CSS types, and the explicit CSS indication is received via a system information block.

In an eleventh aspect, alone or in combination with one or more of the first through tenth aspects, the explicit CSS indication is associated with a single CSS type, and the explicit CSS indication is received via one of a SIB or RRC signaling.

In a twelfth aspect, alone or in combination with one or more of the first through eleventh aspects, the single CSS type is one of a Type 1 CSS, a Type 2 CSS, or a Type 2A CSS, and the explicit CSS indication is received via the SIB or a common PDCCH configuration associated with the RRC signaling.

In a thirteenth aspect, alone or in combination with one or more of the first through twelfth aspects, the single CSS type is a Type 3 CSS, and the explicit CSS indication is received via a search space configuration of the CSS.

In a fourteenth aspect, alone or in combination with one or more of the first through thirteenth aspects, the SBFD set of symbols is a subset of OFDM symbols associated with an SBFD slot, and the configuration information further indicates that only the subset of OFDM symbols overlapping with CSS symbols are to be treated as the non-SBFD set of symbols.

In a fifteenth aspect, alone or in combination with one or more of the first through fourteenth aspects, the SBFD set of symbols is a subset of OFDM symbols associated with an SBFD slot, and the configuration information further indicates that the subset of OFDM symbols overlapping with CSS symbols and an additional set of OFDM symbols in the SBFD slot that are non-overlapping with the CSS symbols are to be treated as the non-SBFD set of symbols.

In a sixteenth aspect, alone or in combination with one or more of the first through fifteenth aspects, the SBFD set of symbols is a subset of OFDM symbols associated with an SBFD slot, and the configuration information further indicates that all OFDM symbols, of the SBFD slot, are to be treated as the non-SBFD set of symbols.

In a seventeenth aspect, alone or in combination with one or more of the first through sixteenth aspects, the indication of whether the SBFD set of symbols is to be treated as the non-SBFD set of symbols indicates that the SBFD set of symbols is not to be treated as the non-SBFD set of symbols, and the process 700 further comprises receiving a scheduling communication that schedules one of a downlink communication or an uplink communication in the SBFD set of symbols.

In an eighteenth aspect, alone or in combination with one or more of the first through seventeenth aspects, the indication of whether the SBFD set of symbols is to be treated as the non-SBFD set of symbols indicates that the SBFD set of symbols is not to be treated as the non-SBFD set of symbols, and the process 700 further comprises refraining from transmitting a semi-statically scheduled uplink transmission in the SBFD set of symbols based at least in part on the SBFD set of symbols not being treated as the non-SBFD set of symbols.

In a nineteenth aspect, alone or in combination with one or more of the first through eighteenth aspects, the indication of whether the SBFD set of symbols is to be treated as the non-SBFD set of symbols indicates that the SBFD set of symbols is not to be treated as the non-SBFD set of symbols, and the process 700 further comprises transmitting a dynamically scheduled uplink transmission in the SBFD set of symbols.

In a twentieth aspect, alone or in combination with one or more of the first through nineteenth aspects, the indication of whether the SBFD set of symbols is to be treated as the non-SBFD set of symbols indicates that the SBFD set of symbols is not to be treated as the non-SBFD set of symbols, and the process 700 further comprises applying at least one of an automatic gain control gain associated with an SBFD slot or a transmission configuration indicator state associated with the SBFD slot based at least in part on the SBFD set of symbols not being treated as the non-SBFD set of symbols.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with CSS collision handling for SBFD sets of symbols.

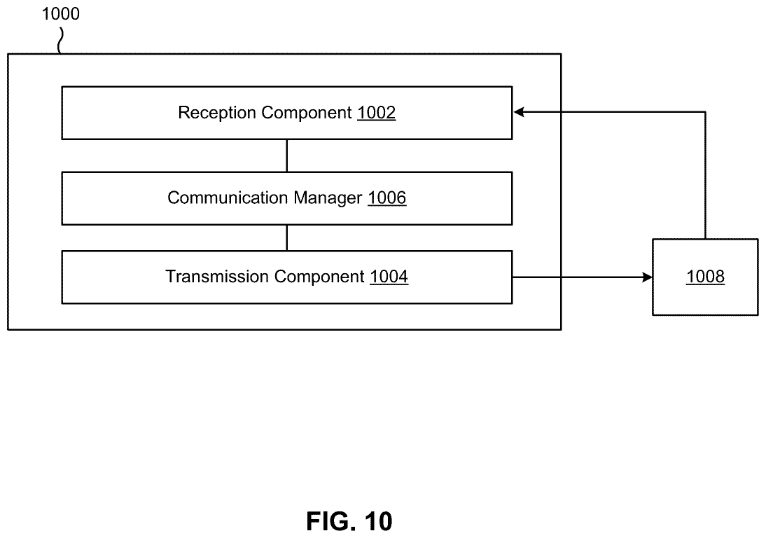

As shown in FIG. 8, in some aspects, process 800 may include transmitting, to a UE, configuration information that schedules a PDCCH communication associated with a CSS in an SBFD set of symbols (block 810). For example, the network node (e.g., using transmission component 1004 and/or communication manager 1006, depicted in FIG. 10) may transmit, to a UE, configuration information that schedules a PDCCH communication associated with a CSS in an SBFD set of symbols, as described above.

As further shown in FIG. 8, in some aspects, process 800 may include transmitting, to the UE, an indication of whether the SBFD set of symbols is to be treated as a non-SBFD set of symbols (block 820). For example, the network node (e.g., using transmission component 1004 and/or communication manager 1006, depicted in FIG. 10) may transmit, to the UE, an indication of whether the SBFD set of symbols is to be treated as a non-SBFD set of symbols, as described above.

As further shown in FIG. 8, in some aspects, process 800 may include performing one of transmitting, to the UE, the PDCCH communication or refraining from transmitting the PDCCH communication based on whether the SBFD set of symbols is to be treated as the non-SBFD set of symbols (block 830). For example, the network node (e.g., using communication manager 1006, depicted in FIG. 10) may perform one of transmitting, to the UE, the PDCCH communication or refraining from transmitting the PDCCH communication based on whether the SBFD set of symbols is to be treated as the non-SBFD set of symbols, as described above.

Process 800 may include additional aspects, such as any single aspect or any combination of aspects described below and/or in connection with one or more other processes described elsewhere herein.

In a first aspect, the indication of whether the SBFD set of symbols is to be treated as the non-SBFD set of symbols is associated with the configuration information, and performing the one of transmitting the PDCCH communication or refraining from transmitting the PDCCH communication includes transmitting the PDCCH communication based at least in part on treating the SBFD set of symbols as the non-SBFD set of symbols.

In a second aspect, alone or in combination with the first aspect, process 800 includes transmitting, to the UE, the PDCCH communication only in one or more downlink sub-bands associated with the SBFD set of symbols.

In a third aspect, alone or in combination with one or more of the first and second aspects, process 800 includes transmitting, to the UE, the PDCCH communication in one or more downlink sub-bands associated with the SBFD set of symbols and one or more uplink sub-bands or guard bands associated with the SBFD set of symbols.

In a fourth aspect, alone or in combination with one or more of the first through third aspects, the indication of whether the SBFD set of symbols is to be treated as the non-SBFD set of symbols is a communication that schedules, in the SBFD set of symbols, an uplink transmission that is associated with a higher priority than a priority of the PDCCH communication, and performing the one of transmitting the PDCCH communication or refraining from transmitting the PDCCH communication includes refraining from transmitting the PDCCH communication based at least in part on transmitting the communication that schedules the uplink transmission.

In a fifth aspect, alone or in combination with one or more of the first through fourth aspects, the indication of whether the SBFD set of symbols is to be treated as the non-SBFD set of symbols is based at least in part on a type of the CSS that is associated with the PDCCH communication.

In a sixth aspect, alone or in combination with one or more of the first through fifth aspects, the type of the CSS is one of a Type 0 CSS or a Type 0A CSS, and performing the one of transmitting the PDCCH communication or refraining from transmitting the PDCCH communication includes transmitting the PDCCH communication based at least in part on the type of the CSS being the one of the Type 0 CSS or the Type 0A CSS.

In a seventh aspect, alone or in combination with one or more of the first through sixth aspects, the indication of whether the SBFD set of symbols is to be treated as the non-SBFD set of symbols is an explicit CSS indication.

In an eighth aspect, alone or in combination with one or more of the first through seventh aspects, the explicit CSS indication indicates that the SBFD set of symbols is to be treated as the non-SBFD set of symbols, and performing the one of transmitting the PDCCH communication or refraining from transmitting the PDCCH communication includes transmitting the PDCCH communication using at least a transmission configuration indicator state associated with the non-SBFD slot.

In a ninth aspect, alone or in combination with one or more of the first through eighth aspects, the explicit CSS indication indicates that the SBFD set of symbols is not to be treated as the non-SBFD set of symbols, and the process 800 further comprises transmitting, to the UE, a scheduling communication scheduling an uplink transmission in the SBFD set of symbols.

In a tenth aspect, alone or in combination with one or more of the first through ninth aspects, the explicit CSS indication is associated with multiple CSS types, and the explicit CSS indication is transmitted via a system information block.

In an eleventh aspect, alone or in combination with one or more of the first through tenth aspects, the explicit CSS indication is associated with a single CSS type, and the explicit CSS indication is transmitted via one of a SIB or RRC signaling.

In a twelfth aspect, alone or in combination with one or more of the first through eleventh aspects, the single CSS type is one of a Type 1 CSS, a Type 2 CSS, or a Type 2A CSS, and the explicit CSS indication is transmitted via the SIB or a common PDCCH configuration associated with the RRC signaling.

In a thirteenth aspect, alone or in combination with one or more of the first through twelfth aspects, the single CSS type is a Type 3 CSS, and the explicit CSS indication is transmitted via a search space configuration of the CSS.

In a fourteenth aspect, alone or in combination with one or more of the first through thirteenth aspects, the SBFD set of symbols is a subset of OFDM symbols associated with an SBFD slot, and the configuration information further indicates that only the subset of OFDM symbols overlapping with CSS symbols are to be treated as the non-SBFD set of symbols.

In a fifteenth aspect, alone or in combination with one or more of the first through fourteenth aspects, the SBFD set of symbols is a subset of OFDM symbols associated with an SBFD slot, and the configuration information further indicates that the subset of OFDM symbols overlapping with CSS symbols and an additional set of OFDM symbols in the SBFD slot that are non-overlapping with the CSS symbols are to be treated as the non-SBFD set of symbols.

In a sixteenth aspect, alone or in combination with one or more of the first through fifteenth aspects, the SBFD set of symbols is a subset of OFDM symbols associated with an SBFD slot, and the configuration information further indicates that all OFDM symbols, of the SBFD slot, are to be treated as the non-SBFD set of symbols.

In a seventeenth aspect, alone or in combination with one or more of the first through sixteenth aspects, the indication of whether the SBFD set of symbols is to be treated as the non-SBFD set of symbols indicates that the SBFD set of symbols is not to be treated as the non-SBFD set of symbols, and the process 800 further comprises transmitting, to the UE, a scheduling communication that schedules one of a downlink communication or an uplink communication in the SBFD set of symbols.

In an eighteenth aspect, alone or in combination with one or more of the first through seventeenth aspects, the indication of whether the SBFD set of symbols is to be treated as the non-SBFD set of symbols indicates that the SBFD set of symbols is not to be treated as the non-SBFD set of symbols, and the process 800 further comprises refraining from receiving a semi-statically scheduled uplink transmission in the SBFD set of symbols based at least in part on the SBFD set of symbols not being treated as the non-SBFD set of symbols.

In a nineteenth aspect, alone or in combination with one or more of the first through eighteenth aspects, the indication of whether the SBFD set of symbols is to be treated as the non-SBFD set of symbols indicates that the SBFD set of symbols is not to be treated as the non-SBFD set of symbols, and the process 800 further comprises receiving, from the UE, a dynamically scheduled uplink transmission in the SBFD set of symbols.

In a twentieth aspect, alone or in combination with one or more of the first through nineteenth aspects, the indication of whether the SBFD set of symbols is to be treated as the non-SBFD set of symbols indicates that the SBFD set of symbols is not to be treated as the non-SBFD set of symbols, and the process 800 further comprises using a transmission configuration indicator state associated with the SBFD slot based at least in part on the SBFD set of symbols not being treated as the non-SBFD set of symbols.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6A-6C. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive configuration information that schedules a PDCCH communication associated with a CSS in an SBFD set of symbols. The reception component 902 may receive an indication of whether the SBFD set of symbols is to be treated as a non-SBFD set of symbols. The communication manager 906 may perform one of receiving the PDCCH communication or refraining from receiving the PDCCH communication based on whether the SBFD set of symbols is to be treated as the non-SBFD set of symbols.

The reception component 902 may receive the PDCCH communication only in one or more downlink sub-bands associated with the SBFD set of symbols.

The reception component 902 may receive the PDCCH communication in one or more downlink sub-bands associated with the SBFD set of symbols and one or more uplink sub-bands or guard bands associated with the SBFD set of symbols.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6A-6C. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, configuration information that schedules a PDCCH communication associated with a CSS in an SBFD set of symbols. The transmission component 1004 may transmit, to the UE, an indication of whether the SBFD set of symbols is to be treated as a non-SBFD set of symbols. The communication manager 1006 may perform one of transmitting, to the UE, the PDCCH communication or refraining from transmitting the PDCCH communication based on whether the SBFD set of symbols is to be treated as the non-SBFD set of symbols.

The transmission component 1004 may transmit, to the UE, the PDCCH communication only in one or more downlink sub-bands associated with the SBFD set of symbols.

The transmission component 1004 may transmit, to the UE, the PDCCH communication in one or more downlink sub-bands associated with the SBFD set of symbols and one or more uplink sub-bands or guard bands associated with the SBFD set of symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving configuration information that schedules a PDCCH communication associated with a CSS in an SBFD set of symbols; receiving an indication of whether the SBFD set of symbols is to be treated as a non-SBFD set of symbols; and performing one of receiving the PDCCH communication or refraining from receiving the PDCCH communication based on whether the SBFD set of symbols is to be treated as the non-SBFD set of symbols.

Aspect 2: The method of Aspect 1, wherein the indication of whether the SBFD set of symbols is to be treated as the non-SBFD set of symbols is associated with the configuration information, and wherein performing the one of receiving the PDCCH communication or refraining from receiving the PDCCH communication includes receiving the PDCCH communication based at least in part on treating the SBFD set of symbols as the non-SBFD set of symbols.

Aspect 3: The method of Aspect 2, further comprising receiving the PDCCH communication only in one or more downlink sub-bands associated with the SBFD set of symbols.

Aspect 4: The method of Aspect 2, further comprising receiving the PDCCH communication in one or more downlink sub-bands associated with the SBFD set of symbols and one or more uplink sub-bands or guard bands associated with the SBFD set of symbols.

Aspect 5: The method of any of Aspects 1-4, wherein the indication of whether the SBFD set of symbols is to be treated as the non-SBFD set of symbols is a communication that schedules, in the SBFD set of symbols, an uplink transmission that is associated with a higher priority than a priority associated with the PDCCH communication, and wherein performing the one of receiving the PDCCH communication or refraining from receiving the PDCCH communication includes refraining from receiving the PDCCH communication based at least in part on receiving the communication that schedules the uplink transmission.

Aspect 6: The method of any of Aspects 1-5, wherein the indication of whether the SBFD set of symbols is to be treated as the non-SBFD set of symbols is based at least in part on a type of the CSS that is associated with the PDCCH communication.

Aspect 7: The method of Aspect 6, wherein the type of the CSS is one of a Type 0 CSS or a Type 0A CSS, and wherein performing the one of receiving the PDCCH communication or refraining from receiving the PDCCH communication includes receiving the PDCCH communication based at least in part on the type of the CSS being the one of the Type 0 CSS or the Type 0A CSS.

Aspect 8: The method of any of Aspects 1-7, wherein the indication of whether the SBFD set of symbols is to be treated as the non-SBFD set of symbols is an explicit CSS indication.

Aspect 9: The method of Aspect 8, wherein the explicit CSS indication indicates that the SBFD set of symbols is to be treated as the non-SBFD set of symbols, and wherein performing the one of receiving the PDCCH communication or refraining from receiving the PDCCH communication includes receiving the PDCCH communication based at least in part on applying at least one of an automatic gain control gain associated with a non-SBFD slot or a transmission configuration indicator state associated with the non-SBFD slot.

Aspect 10: The method of Aspect 8, wherein the explicit CSS indication indicates that the SBFD set of symbols is not to be treated as the non-SBFD set of symbols, and wherein the method further comprises receiving a scheduling communication scheduling an uplink transmission in the SBFD set of symbols.

Aspect 11: The method of Aspect 8, wherein the explicit CSS indication is associated with multiple CSS types, and wherein the explicit CSS indication is received via a system information block.

Aspect 12: The method of Aspect 8, wherein the explicit CSS indication is associated with a single CSS type, and wherein the explicit CSS indication is received via one of a SIB or RRC signaling.

Aspect 13: The method of Aspect 12, wherein the single CSS type is one of a Type 1 CSS, a Type 2 CSS, or a Type 2A CSS, and wherein the explicit CSS indication is received via the SIB or a common PDCCH configuration associated with the RRC signaling.

Aspect 14: The method of Aspect 12, wherein the single CSS type is a Type 3 CSS, and wherein the explicit CSS indication is received via a search space configuration of the CSS.

Aspect 15: The method of any of Aspects 1-14, wherein the SBFD set of symbols is a subset of OFDM symbols associated with an SBFD slot, and wherein the configuration information further indicates that only the subset of OFDM symbols overlapping with CSS symbols are to be treated as the non-SBFD set of symbols.

Aspect 16: The method of any of Aspects 1-14, wherein the SBFD set of symbols is a subset of OFDM symbols associated with an SBFD slot, and wherein the configuration information further indicates that the subset of OFDM symbols overlapping with CSS symbols and an additional set of OFDM symbols in the SBFD slot that are non-overlapping with the CSS symbols are to be treated as the non-SBFD set of symbols.

Aspect 17: The method of any of Aspects 1-14, wherein the SBFD set of symbols is a subset of OFDM symbols associated with an SBFD slot, and wherein the configuration information further indicates that all OFDM symbols, of the SBFD slot, are to be treated as the non-SBFD set of symbols.

Aspect 18: The method of any of Aspects 1-17, wherein the indication of whether the SBFD set of symbols is to be treated as the non-SBFD set of symbols indicates that the SBFD set of symbols is not to be treated as the non-SBFD set of symbols, and wherein the method further comprises receiving a scheduling communication that schedules one of a downlink communication or an uplink communication in the SBFD set of symbols.

Aspect 19: The method of any of Aspects 1-18, wherein the indication of whether the SBFD set of symbols is to be treated as the non-SBFD set of symbols indicates that the SBFD set of symbols is not to be treated as the non-SBFD set of symbols, and wherein the method further comprises refraining from transmitting a semi-statically scheduled uplink transmission in the SBFD set of symbols based at least in part on the SBFD set of symbols not being treated as the non-SBFD set of symbols.

Aspect 20: The method of any of Aspects 1-19, wherein the indication of whether the SBFD set of symbols is to be treated as the non-SBFD set of symbols indicates that the SBFD set of symbols is not to be treated as the non-SBFD set of symbols, and wherein the method further comprises transmitting a dynamically scheduled uplink transmission in the SBFD set of symbols.

Aspect 21: The method of any of Aspects 1-20, wherein the indication of whether the SBFD set of symbols is to be treated as the non-SBFD set of symbols indicates that the SBFD set of symbols is not to be treated as the non-SBFD set of symbols, and wherein the method further comprises applying at least one of an automatic gain control gain associated with an SBFD slot or a transmission configuration indicator state associated with the SBFD slot based at least in part on the SBFD set of symbols not being treated as the non-SBFD set of symbols.

Aspect 22: A method of wireless communication performed by a network node, comprising: transmitting, to a UE, configuration information that schedules a PDCCH communication associated with a CSS in an SBFD set of symbols; transmitting, to the UE, an indication of whether the SBFD set of symbols is to be treated as a non-SBFD set of symbols; and performing one of transmitting, to the UE, the PDCCH communication or refraining from transmitting the PDCCH communication based on whether the SBFD set of symbols is to be treated as the non-SBFD set of symbols.

Aspect 23: The method of Aspect 22, wherein the indication of whether the SBFD set of symbols is to be treated as the non-SBFD set of symbols is associated with the configuration information, and wherein performing the one of transmitting the PDCCH communication or refraining from transmitting the PDCCH communication includes transmitting the PDCCH communication based at least in part on treating the SBFD set of symbols as the non-SBFD set of symbols.

Aspect 24: The method of Aspect 23, further comprising transmitting, to the UE, the PDCCH communication only in one or more downlink sub-bands associated with the SBFD set of symbols.

Aspect 25: The method of Aspect 23, further comprising transmitting, to the UE, the PDCCH communication in one or more downlink sub-bands associated with the SBFD set of symbols and one or more uplink sub-bands or guard bands associated with the SBFD set of symbols.

Aspect 26: The method of any of Aspects 22-25, wherein the indication of whether the SBFD set of symbols is to be treated as the non-SBFD set of symbols is a communication that schedules, in the SBFD set of symbols, an uplink transmission that is associated with a higher priority than a priority of the PDCCH communication, and wherein performing the one of transmitting the PDCCH communication or refraining from transmitting the PDCCH communication includes refraining from transmitting the PDCCH communication based at least in part on transmitting the communication that schedules the uplink transmission.

Aspect 27: The method of any of Aspects 22-26, wherein the indication of whether the SBFD set of symbols is to be treated as the non-SBFD set of symbols is based at least in part on a type of the CSS that is associated with the PDCCH communication.

Aspect 28: The method of Aspect 27, wherein the type of the CSS is one of a Type 0 CSS or a Type 0A CSS, and wherein performing the one of transmitting the PDCCH communication or refraining from transmitting the PDCCH communication includes transmitting the PDCCH communication based at least in part on the type of the CSS being the one of the Type 0 CSS or the Type 0A CSS.

Aspect 29: The method of any of Aspects 22-28, wherein the indication of whether the SBFD set of symbols is to be treated as the non-SBFD set of symbols is an explicit CSS indication.

Aspect 30: The method of Aspect 29, wherein the explicit CSS indication indicates that the SBFD set of symbols is to be treated as the non-SBFD set of symbols, and wherein performing the one of transmitting the PDCCH communication or refraining from transmitting the PDCCH communication includes transmitting the PDCCH communication using at least a transmission configuration indicator state associated with the non-SBFD slot.

Aspect 31: The method of Aspect 29, wherein the explicit CSS indication indicates that the SBFD set of symbols is not to be treated as the non-SBFD set of symbols, and wherein the method further comprises transmitting, to the UE, a scheduling communication scheduling an uplink transmission in the SBFD set of symbols.

Aspect 32: The method of Aspect 29, wherein the explicit CSS indication is associated with multiple CSS types, and wherein the explicit CSS indication is transmitted via a system information block.

Aspect 33: The method of Aspect 29, wherein the explicit CSS indication is associated with a single CSS type, and wherein the explicit CSS indication is transmitted via one of a SIB or RRC signaling.

Aspect 34: The method of Aspect 33, wherein the single CSS type is one of a Type 1 CSS, a Type 2 CSS, or a Type 2A CSS, and wherein the explicit CSS indication is transmitted via the SIB or a common PDCCH configuration associated with the RRC signaling.

Aspect 35: The method of Aspect 33, wherein the single CSS type is a Type 3 CSS, and wherein the explicit CSS indication is transmitted via a search space configuration of the CSS.

Aspect 36: The method of any of Aspects 22-35, wherein the SBFD set of symbols is a subset of OFDM symbols associated with an SBFD slot, and wherein the configuration information further indicates that only the subset of OFDM symbols overlapping with CSS symbols are to be treated as the non-SBFD set of symbols.

Aspect 37: The method of any of Aspects 22-35, wherein the SBFD set of symbols is a subset of OFDM symbols associated with an SBFD slot, and wherein the configuration information further indicates that the subset of OFDM symbols overlapping with CSS symbols and an additional set of OFDM symbols in the SBFD slot that are non-overlapping with the CSS symbols are to be treated as the non-SBFD set of symbols.

Aspect 38: The method of any of Aspects 22-35, wherein the SBFD set of symbols is a subset of OFDM symbols associated with an SBFD slot, and wherein the configuration information further indicates that all OFDM symbols, of the SBFD slot, are to be treated as the non-SBFD set of symbols.

Aspect 39: The method of any of Aspects 22-38, wherein the indication of whether the SBFD set of symbols is to be treated as the non-SBFD set of symbols indicates that the SBFD set of symbols is not to be treated as the non-SBFD set of symbols, and wherein the method further comprises transmitting, to the UE, a scheduling communication that schedules one of a downlink communication or an uplink communication in the SBFD set of symbols.

Aspect 40: The method of any of Aspects 22-39, wherein the indication of whether the SBFD set of symbols is to be treated as the non-SBFD set of symbols indicates that the SBFD set of symbols is not to be treated as the non-SBFD set of symbols, and wherein the method further comprises refraining from receiving a semi-statically scheduled uplink transmission in the SBFD set of symbols based at least in part on the SBFD set of symbols not being treated as the non-SBFD set of symbols.

Aspect 41: The method of any of Aspects 22-40, wherein the indication of whether the SBFD set of symbols is to be treated as the non-SBFD set of symbols indicates that the SBFD set of symbols is not to be treated as the non-SBFD set of symbols, and wherein the method further comprises receiving, from the UE, a dynamically scheduled uplink transmission in the SBFD set of symbols.

Aspect 42: The method of any of Aspects 22-41, wherein the indication of whether the SBFD set of symbols is to be treated as the non-SBFD set of symbols indicates that the SBFD set of symbols is not to be treated as the non-SBFD set of symbols, and wherein the method further comprises using a transmission configuration indicator state associated with the SBFD slot based at least in part on the SBFD set of symbols not being treated as the non-SBFD set of symbols.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, which are configured, individually or in any combination, to:
receive configuration information that schedules a physical downlink control channel (PDCCH) communication associated with a common search space (CSS) in a sub-band full duplex (SBFD) set of symbols;
receive an indication of whether the SBFD set of symbols is to be treated as a non-SBFD set of symbols; and
perform one of receiving the PDCCH communication or refraining from receiving the PDCCH communication based on whether the SBFD set of symbols is to be treated as the non-SBFD set of symbols.

2. The UE of claim 1, wherein the indication of whether the SBFD set of symbols is to be treated as the non-SBFD set of symbols is associated with the configuration information, and
wherein the one or more processors, to perform the one of receiving the PDCCH communication or refraining from receiving the PDCCH communication, are configured to receive the PDCCH communication based at least in part on treating the SBFD set of symbols as the non-SBFD set of symbols.

3. The UE of claim 1, wherein the indication of whether the SBFD set of symbols is to be treated as the non-SBFD set of symbols is a communication that schedules, in the SBFD set of symbols, an uplink transmission that is associated with a higher priority than a priority associated with the PDCCH communication, and
wherein the one or more processors, to perform the one of receiving the PDCCH communication or refraining from receiving the PDCCH communication, are configured to refrain from receiving the PDCCH communication based at least in part on receiving the communication that schedules the uplink transmission.

4. The UE of claim 1, wherein the indication of whether the SBFD set of symbols is to be treated as the non-SBFD set of symbols is based at least in part on a type of the CSS that is associated with the PDCCH communication.

5. The UE of claim 1, wherein the indication of whether the SBFD set of symbols is to be treated as the non-SBFD set of symbols is an explicit CSS indication.

6. The UE of claim 5, wherein the explicit CSS indication indicates that the SBFD set of symbols is to be treated as the non-SBFD set of symbols, and
wherein the one or more processors, to perform the one of receiving the PDCCH communication or refraining from receiving the PDCCH communication, are configured to receive the PDCCH communication based at least in part on applying at least one of an automatic gain control gain associated with a non-SBFD slot or a transmission configuration indicator state associated with the non-SBFD slot.

7. The UE of claim 5, wherein the explicit CSS indication indicates that the SBFD set of symbols is not to be treated as the non-SBFD set of symbols, and
wherein the one or more processors are further configured to receive a scheduling communication scheduling an uplink transmission in the SBFD set of symbols.

8. The UE of claim 5, wherein the explicit CSS indication is associated with multiple CSS types, and
wherein the one or more processors are further configured to receive the explicit CSS indication via a system information block.

9. The UE of claim 5, wherein the explicit CSS indication is associated with a single CSS type, and
wherein the one or more processors are further configured to receive the explicit CSS indication via one of a system information block (SIB) or radio resource control (RRC) signaling.

10. The UE of claim 9, wherein the single CSS type is one of a Type 1 CSS, a Type 2 CSS, or a Type 2A CSS, and
wherein the one or more processors are further configured to receive the explicit CSS indication via the SIB or a common PDCCH configuration associated with the RRC signaling.

11. The UE of claim 9, wherein the single CSS type is a Type 3 CSS, and
wherein the one or more processors are further configured to receive the explicit CSS indication via a search space configuration of the CSS.

12. The UE of claim 1, wherein the SBFD set of symbols is a subset of orthogonal frequency division multiplexing (OFDM) symbols associated with an SBFD slot, and
wherein the configuration information further indicates that only the subset of OFDM symbols overlapping with CSS symbols are to be treated as the non-SBFD set of symbols.

13. The UE of claim 1, wherein the SBFD set of symbols is a subset of orthogonal frequency division multiplexing (OFDM) symbols associated with an SBFD slot, and
wherein the configuration information further indicates that the subset of OFDM symbols overlapping with CSS symbols and an additional set of OFDM symbols in the SBFD slot that are non-overlapping with the CSS symbols are to be treated as the non-SBFD set of symbols.

14. The UE of claim 1, wherein the SBFD set of symbols is a subset of orthogonal frequency division multiplexing (OFDM) symbols associated with an SBFD slot, and
wherein the configuration information further indicates that all OFDM symbols, of the SBFD slot, are to be treated as the non-SBFD set of symbols.

15. The UE of claim 1, wherein the indication of whether the SBFD set of symbols is to be treated as the non-SBFD set of symbols indicates that the SBFD set of symbols is not to be treated as the non-SBFD set of symbols, and
wherein the one or more processors are further configured to receive a scheduling communication that schedules one of a downlink communication or an uplink communication in the SBFD set of symbols.

16. The UE of claim 1, wherein the indication of whether the SBFD set of symbols is to be treated as the non-SBFD set of symbols indicates that the SBFD set of symbols is not to be treated as the non-SBFD set of symbols, and
wherein the one or more processors are further configured to refrain from transmitting a semi-statically scheduled uplink transmission in the SBFD set of symbols based at least in part on the SBFD set of symbols not being treated as the non-SBFD set of symbols.

17. The UE of claim 1, wherein the indication of whether the SBFD set of symbols is to be treated as the non-SBFD set of symbols indicates that the SBFD set of symbols is not to be treated as the non-SBFD set of symbols, and
wherein the one or more processors are further configured to transmit a dynamically scheduled uplink transmission in the SBFD set of symbols.

18. The UE of claim 1, wherein the indication of whether the SBFD set of symbols is to be treated as the non-SBFD set of symbols indicates that the SBFD set of symbols is not to be treated as the non-SBFD set of symbols, and
wherein the one or more processors are further configured to apply at least one of an automatic gain control gain associated with an SBFD slot or a transmission configuration indicator state associated with the SBFD slot based at least in part on the SBFD set of symbols not being treated as the non-SBFD set of symbols.

19. A method of wireless communication performed by a user equipment (UE), comprising:
receiving configuration information that schedules a physical downlink control channel (PDCCH) communication associated with a common search space (CSS) in a sub-band full duplex (SBFD) set of symbols;
receiving an indication of whether the SBFD set of symbols is to be treated as a non-SBFD set of symbols; and
performing one of receiving the PDCCH communication or refraining from receiving the PDCCH communication based on whether the SBFD set of symbols is to be treated as the non-SBFD set of symbols.

20. A non-transitory computer-readable medium storing a set of instructions for wireless communication, the set of instructions comprising:
one or more instructions that, when executed by one or more processors of a user equipment (UE), cause the UE to:
receive configuration information that schedules a physical downlink control channel (PDCCH) communication associated with a common search space (CSS) in a sub-band full duplex (SBFD) set of symbols;
receive an indication of whether the SBFD set of symbols is to be treated as a non-SBFD set of symbols; and
perform one of receiving the PDCCH communication or refraining from receiving the PDCCH communication based on whether the SBFD set of symbols is to be treated as the non-SBFD set of symbols.
